(19) United States
(12) Patent Application Publication
(10) Pub. No.: US 2025/0060714 A1
(43) Pub. Date: Feb. 20, 2025

(54) DEVICE CONTROL METHOD

(71) Applicant: LUMI UNITED TECHNOLOGY CO., LTD., Shenzhen (CN)

(72) Inventors: Yongheng SONG, Shenzhen (CN); Canwu HUANG, Shenzhen (CN); Eugene Yanjun YOU, Shenzhen (CN)

(73) Assignee: Lumi United Technology Co., Ltd., Shenzhen, GD (CN)

(21) Appl. No.: 18/920,955

(22) Filed: Oct. 20, 2024

Related U.S. Application Data
(63) Continuation-in-part of application No. PCT/CN2023/089576, filed on Apr. 20, 2023.
(63) Continuation-in-part of application No. PCT/CN2023/093300, filed on May 10, 2023.

(30) Foreign Application Priority Data
Apr. 21, 2022 (CN) 202210423101.4
May 23, 2022 (CN) 202210565411.X

(51) Int. Cl. G05B 15/02; H04L 67/125

(52) U.S. Cl. CPC G05B 15/02; H04L 67/125

(57) ABSTRACT

An embodiment of the present disclosure provides a device control method, which includes: obtaining a scene control instruction for multiple devices, wherein the scene control instruction is configured to instruct the multiple devices to execute corresponding scene actions respectively; identifying first devices in the multiple devices, wherein the first device is a device that has been configured with scene action record; if at least one first device is identified, sending the scene control instruction to the first devices in a multicast transmission mode to instruct the first devices to respond to the scene control instruction and synchronously execute a scene action recorded for the first devices in the scene action record.

### CROSS REFERENCE TO RELATED APPLICATIONS

The present disclosure is a continuation-in-part of International (PCT) Patent Application PCT/CN2023/093300 filed on May 10, 2023, which claims priority of Chinese patent application No. CN 202210565411.X filed on May 23, 2022, and International (PCT) Patent Application PCT/CN2023/089576 filed on Apr. 20, 2023, which claims priority of Chinese patent application No. CN 202210423101.4 filed on Apr. 21, 2022. The entire contents of the above-identified applications are incorporated herein by reference.

### TECHNICAL FIELD

The present disclosure relates to the technical field of Internet of Things (IoT), and in particular, the present disclosure relates to a device control method.

### BACKGROUND

With rapid development of IoT technology, application of smart devices is gradually becoming widespread. In order to improve convenience of users' operation on smart devices, not only can device linkage be set, for example, if it is detected that someone is in a living room, lights are automatically turned on, but also various modes can be set, for example, when a user leaves home, air conditioning, lights, socket switches, and so on are automatically turned off through a home leaving mode.

However, current control aiming at multiple smart devices, such as multiple smart devices in a home leaving mode, often requires controlling them one by one based on multiple instructions. It can also be considered that multiple smart devices need to execute corresponding setting actions in sequence, which results in significant network latency and is prone to affect users' using experience.

As can be seen from the above, how to reduce network latency of multiple devices executing multiple actions still needs to be solved.

### SUMMARY OF THE DISCLOSURE

Embodiments of the present disclosure provide a device control method, which can solve the problem existing in the related art that network latency of multiple devices executing multiple actions is significant. The technical solutions are as follows.

According to one aspect of embodiments of the present disclosure, a device control method executed by a server end is provided, the method comprises: obtaining a scene control instruction for multiple devices, wherein the scene control instruction is configured to instruct the multiple devices to execute corresponding scene actions respectively; identifying first devices in the multiple devices, wherein the first device is a device that has been configured with scene action record; if at least one first device is identified, sending the scene control instruction to the first devices in a multicast transmission mode to instruct the first devices to respond to the scene control instruction and synchronously execute a scene action recorded for the first devices in the scene action record.

According to one aspect of embodiments of the present disclosure, a device control method executed by a smart device is provided, the method comprises: receiving a scene control instruction for multiple devices, wherein the scene control instruction is configured to instruct the multiple devices to execute corresponding scene actions respectively; based on configured scene action record, and in response to the scene control instruction, executing a scene action related to the smart device oneself in the scene action record.

According to one aspect of embodiments of the present disclosure, a device control method executed by a user terminal is provided, the method comprises: displaying at least one control entrance for a virtual device, wherein the virtual device is established by at least two devices that are allowed to execute at least one identical scene action; in response to a trigger operation for the control entrance, generating a virtual device control instruction, wherein the virtual device control instruction is configured to instruct the virtual device to execute a set scene action corresponding to the control entrance, wherein the set scene action belongs to scene actions that are allowed to be executed by the at least two devices establishing the virtual device; sending the virtual device control instruction to the virtual device, such that the at least two device establishing the virtual device respond the virtual device control instruction and synchronously execute the set scene action.

### BRIEF DESCRIPTION OF THE DRAWINGS

In order to explain technical solutions in embodiments of the present disclosure more clearly, drawings required to be used in description of the embodiments of the present disclosure art will be briefly introduced below. It is obvious that the drawings in the following description are only some embodiments of the present disclosure. For one of ordinary skill in the art, other drawings can be further obtained according to these drawings on the premise of paying no creative work.

FIG. 1 is a schematic diagram of an implementation environment involved by an embodiment of the present disclosure.

FIG. 2 is a method flowchart of a scene construction process involved by an embodiment of the present disclosure.

FIG. 3 is a first schematic diagram of a scene construction process involved by an embodiment of the present disclosure.

FIG. 4 is a second schematic diagram of a scene construction process involved by an embodiment of the present disclosure.

FIG. 5 is a flowchart of a device control method shown according to an exemplary embodiment.

FIG. 6 is a method flowchart of scene action record configuration process shown according to an exemplary embodiment.

FIG. 7 is a flowchart of the step 430 involved by the embodiment corresponding to FIG. 6 in an embodiment.

FIG. 8 is a flowchart of another device control method shown according to an exemplary embodiment.

FIG. 9 is a flowchart of another device control method shown according to an exemplary embodiment.

FIG. 10 is a schematic diagram of a device detail page of a virtual device shown according to an exemplary embodiment.

FIG. 11 is a method flowchart of a virtual device establishing process shown according to an exemplary embodiment.

FIG. 12 is a schematic diagram of a device list page displaying smart devices shown according to an exemplary embodiment.

FIG. 13 is a flowchart of the step 730 shown in the embodiment corresponding to FIG. 11 in an embodiment.

FIG. 14 is a schematic diagram of a device detail page of a target device and a jumping process thereof shown according to an exemplary embodiment.

FIG. 15 is a schematic diagram of a virtual device establishing page of a target device and a jumping process thereof shown according to an exemplary embodiment.

FIG. 16 is a flowchart of the step 750 shown in the embodiment corresponding to FIG. 11 in an embodiment.

FIG. 17 is a schematic diagram of adding a virtual device shown according to an exemplary embodiment.

FIG. 18 is a schematic diagram about a page jumping process of a virtual device shown according to an exemplary embodiment.

FIG. 19 is a time sequence interaction diagram of a device control method in an application scene involved by an exemplary embodiment.

FIG. 20 is a schematic diagram of a gateway sending device control instructions to a first device and a second device respectively shown according to an exemplary embodiment.

FIG. 21 is a flowchart of another device control method shown according to an exemplary embodiment.

FIG. 22 is a schematic diagram of a gateway sending different instructions to a first device and a second device shown according to an exemplary embodiment.

FIG. 23 is a flowchart of another device control method shown according to an exemplary embodiment.

FIG. 24 is a structural block diagram of a device control apparatus shown according to an exemplary embodiment.

FIG. 25 is a structural block diagram of another device control apparatus shown according to an exemplary embodiment.

FIG. 26 is a structural block diagram of another device control apparatus shown according to an exemplary embodiment.

FIG. 27 is a structural block diagram of a device control system shown according to an exemplary embodiment.

FIG. 28 is a hardware structural diagram of a device shown according to

an exemplary embodiment.

FIG. 29 is a hardware structural diagram of a device shown according to an exemplary embodiment.

FIG. 30 is a structural block diagram of a device shown according to an exemplary embodiment.

### DETAILED DESCRIPTION

Embodiments of the present disclosure will be described in detail below. Examples of the embodiments are shown in the accompanying drawings, wherein identical or similar reference numbers from beginning to end represent identical or similar elements or elements with identical or similar functions. The embodiments described below with reference to the accompanying drawings are exemplary and are only used to explain the present disclosure, and cannot be interpreted as limiting the present disclosure.

Technicians in this technical field can understand that unless specifically stated, the singular forms “a/an”, “one”, “said”, and “the” used here may also include plural forms. It should be further understood that the term “include” used in the specification of the present disclosure refers to the presence of the described features, integers, steps, operations, elements, and/or components, but does not exclude the presence or addition of one or more other features, integers, steps, operations, elements, components, and/or combinations thereof. It should be understood that when we refer to a component as being “connected” or “coupled” to another component, it can be directly connected or coupled to another component, or there may also exist an intermediate component. In addition, “connection” or “coupling” used here may include wireless connection or wireless coupling. The wording “and/or” used here includes all or any units and all combinations of one or more associated listed items.

The following are introduction and explanation for several nouns involved by the present disclosure.
Multicast: also known as multi-objective broadcasting or multiple-cast, is a point to multi-point network communication method. It is also considered as a network communication method for transmitting data between one sender and multiple receivers. The sender only sends one piece of data, and the data received by all of the multiple receivers is a copy of this piece data, that is, the same data.
Unicast: it is a point-to-point network communication method, which is mainly used for data transmission between one sender and one receiver. If it needs to be applied to transmission of the same data between one sender and multiple receivers, the difference from multicast is that the sender still needs to send multiple copies of the same data.

Advantageous effect brought by technical solutions provided by the present disclosure is as follows.

In above technical solutions, based on an obtained scene control instruction for multiple devices, the scene control instruction is used for instructing the devices to respectively execute corresponding scene actions. Thus, if it is identified that at least one first device, that is, a device that has been configured with scene action record, the scene control instruction can be sent to the first devices according to a multicast transmission mode, so as to instruct the first devices to respond the scene control instruction and execute a scene action recorded by the first device in the scene action record. In other words, by the way of scene action record, a scene action executed correspondingly by at least one first device is recorded and configured for the first device; thus, during a device control process, by sending the scene control instruction to the first devices in the multicast transmission mode, the first devices can be controlled to synchronously execute corresponding scene actions recorded by the first devices in the configured scene action record, thereby avoiding controlling multiple smart devices one by one based on multiple instruction, that is, avoiding multiple smart devices from sequentially executing corresponding set actions. Thus, network latency of multiple devices executing multiple actions is reduced, such that the problem of large network latency of multiple devices executing multiple actions existing in the related art can be effectively solved.

In order to make purposes, technical solutions, and advantages of the present disclosure be clearer, embodiments of the present disclosure will be further described in detail below in combination with drawings.

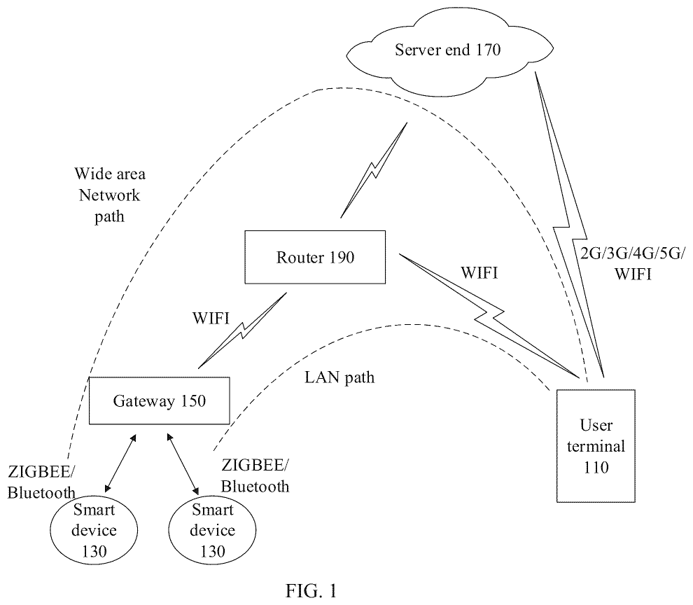

FIG. 1 is a schematic diagram of an implementation environment involved by an embodiment of the present disclosure. The implementation environment includes a user terminal 110, a smart device 130, a gateway 150, a server end 170, and a router 190.

Specifically, the user terminal 110, which may also be considered as a user end or a terminal, can perform deployment (which can also be considered as installment) of a client end associated with the smart device 130; the user terminal 110 may be electronic devices such as smartphones, tablets, laptops, desktop computers, smart control panels, and other devices with display and control functions, and is not limited here.

Among them, associating the client end with the smart device 130 is essentially that a user registers an account in the client end and perform configuration for the smart device 130 in the client. For example, the configuration includes adding a device identifier for the smart device 130 and the like, such that when the client end is running in the user terminal 110, functions such as device control related to the smart device 130 can be provided for the user. The client end can be in the form of application programs, and can also be in the form of web pages; correspondingly, an interface of the client end for device display can be in the form of program windows, and can also be in the form of web pages, which are not limited here.

The smart device 130 is deployed in the gateway 150, communicates with the gateway 150 through its own configured communication module, and thus is controlled by the gateway 150. It should be understood that the smart device 130 generally refers to one of multiple smart devices 130, and the embodiment of the present disclosure only uses a smart device 130 as an example; that is, this embodiment of the present disclosure does not limit the number and device types of smart devices deployed in the gateway 150. In one application scene, the smart device 130 accesses the gateway 150 through a local area network, and is thereby deployed in the gateway 150. A process of the smart device 130 accessing the gateway 150 through a local area network includes: a local area network is established by the gateway 150 at first, and the smart device 130, by connecting the gateway 150, joins in the local area network established by the gateway 150. The local area network includes but is not limited to ZIGBEE or Bluetooth. Among them, the smart device 130 can be smart printers, smart fax machines, smart cameras, smart air conditioners, smart door locks, smart lights, smart fans, smart speakers, or electronic devices equipped with communication modules such as human sensors, door and window sensors, temperature and humidity sensors, water immersion sensors, natural gas alarms, smoke alarms, wall switches, wall sockets, wireless switches, wireless wall sticker switches, Rubik's Cube controllers, curtain motors, etc. It should be understood that the aforesaid user terminal 110 can also be regarded as a kind of smart device 130.

Interaction between the user terminal 110 and the smart device 130 can be realized by a local area network, and can also be realized by a wide area network. In an application scene, the user terminal 110 establishes communication connection in wired or wireless forms with the gateway 150 through the router 190, for example, the wired or wireless forms include but are not limited to WIFI or the like, so that the user terminal 110 and the gateway 150 are deployed in the same local area network, and thus the user terminal 110 is enabled to achieve interaction with the smart device 130 through a local area network path. In another application scene, the user terminal 110 establishes communication connection in wired or wireless forms with the gateway 150 through the server end 170, for example, the wired or wireless forms include but do not limited to 2G, 3G, 4G, 5G, WIFI, etc., so that the user terminal 110 and the gateway 150 are deployed in the same wide area network, and thus the user terminal 110 is enabled to achieve interaction with the smart device 130 through a wide area network path.

Among them, the server end 170 can also be considered as a cloud, a cloud platform, a platform side, a server side, etc. The server side 170 can be a single server, and can also be a server cluster composed of multiple servers, or a cloud computing center composed of multiple servers, so as to better provide background services to a large amount of user terminals 110. For example, the background services include but are not limited to device control services, and so on.

Furthermore, based on interaction among the user terminal 110, the gateway 150, the server end 170, and the smart device 130, a user can further generate a virtual device control instruction configured to control a virtual device (definition and features thereof will be described in detail below) to execute a set scene action using the user terminal 110, and sends the virtual device control instruction to at least two smart devices 130 establishing the virtual device according to a multicast transmission mode through the gateway 150 or the server end 170, so that the at least two smart device 130 respond to the virtual device control instruction and synchronously execute the set scene action, thus the user conveniently realizes synchronous control for multiple smart devices 130.

It is worth mentioning that, compared with the user terminal 110 which can be considered as a user end, both the server end 170 and the gateway 150 can be considered as embodiments of a server end, and are not specifically limited here.

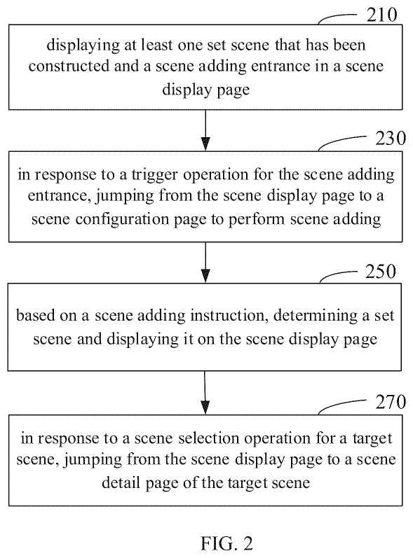

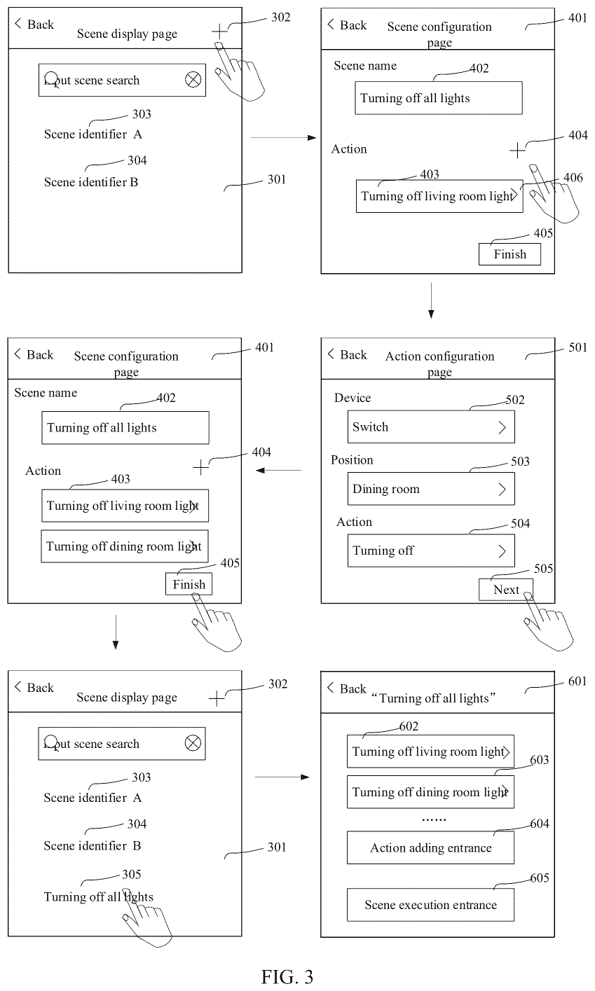

After introducing an application environment involved by an embodiment of the present disclosure, a scene construction process involved by an embodiment of the present disclosure is introduced below in combination with FIG. 2 and FIG. 3. Among them, FIG. 2 shows a method flowchart of a scene construction process in an embodiment, FIG. 3 shows a schematic diagram of a scene construction process in a user terminal in an embodiment.

As shown in FIG. 2, a scene construction process can include the followings steps.

Step 210, displaying at least one scene that has been constructed and a scene adding entrance in a scene display page.

As shown in FIG. 3, in a scene display page 301, a scene 303 and a scene 304 that have been constructed and a scene adding entrance 302 are displayed. It should be noted that scenes are uniquely represented by scene identifiers, similarly, smart devices are uniquely represented by device identifiers, and scene actions are uniquely represented by action identifiers. These identifiers can be in the form of letters, numbers, strings, text, graphics, etc., and are not limited here. For example, a scene identifier A uniquely represents the scene 303, and a scene identifier B uniquely represents the scene 304.

Step 230, in response to a trigger operation for the scene adding entrance, jumping from the scene display page to a scene configuration page to perform scene adding.

In a possible implementation, at least one action that has been configured, as well as a scene name configuration entrance and an action adding entrance are displayed in the scene configuration page.

As shown in FIG. 3, if a user clicks the “+” control 302 in the scene display page 301, the scene display page 301 jumps to a scene configuration page 401. At the same time, in the scene configuration page 401, not only is a configured action “turning off the living room light” 403 displayed, but also a scene name configuration entrance 402 and an action adding entrance 404 are displayed. Among them, the clicking operation of the user is regarded as a trigger operation for the scene configuration entrance.

Step 250, based on a scene adding instruction, adding a scene and displaying it on the scene display page.

In a possible implementation, the scene adding instruction is triggered by at least one of the following operations: an inputting operation used to input a scene identifier for a scene; an action configuration operation used to configure at least one smart device for executing a corresponding scene action in a scene; and a scene confirming operation used to confirm completion of scene adding.

As shown in FIG. 3, in the inputting control 402, “turning off all lights” can be input for a scene and serve as a scene identifier of a set device, and the inputting operation of this user is regarded as an inputting operation; if a user clicks a “+” control 404 in the scene configuration page 401, it is represented that the user desires adding a scene action executed by a smart device in the scene, alternatively, if the user clicks a “>” control 406, it is represented that the user desires modifying a scene action executed by a smart device in the scene, the aforesaid clicking operations of this user can be all regarded as action configuration operations; if the user clicks a “finish” control 405, it is represented that the user confirms completion of scene adding, the clicking operation of the user is regarded as a scene confirming operation. Based on at least one of the aforesaid operations, it is possible to trigger generating a scene adding instruction, confirm that a scene is represented by a scene identifier “turning off all lights”, and display it, i.e., “turning off all lights”, on the scene display page 301.

Optionally, the step 250 can further include the following steps: in response to an action configuration operation, jumping from the scene configuration page to an action configuration page; based on an action configuration instruction triggered in the action configuration page, confirming a scene action executed by a smart device in the scene and displaying it in the scene configuration page.

In a possible implementation, the action configuration instruction is triggered by at least one of the following operation: a device selection operation used to select a smart device for a scene; a position selection operation used to select a deploying position for the smart device selected in the scene, wherein the deploying position includes but is not limited to: a master bedroom, a guest bedroom, a bathroom, a dining room, a living room, a study room, a storage room, a dressing room, a balcony, a kitchen, a hallway, etc., and it can also be considered that the the deploying position specifically limits a type of the smart device, for example, if a deploying position of “switch” is a dining room, it is represented that the smart device is a “dining room light”; alternatively, if the deploying position of “switch” is a living room, it is represented that the smart device is a “living room light”; an action selection operation used to select a scene action for the smart device selected in the scene; and an position selection operation used to confirm configuration of the scene action in the scene.

As shown in FIG. 3, in the selection control 502, “switch” connected with a light can be selected for the scene and serve as a smart device selected for the scene, the selection operation of the user is regarded as a device selection operation; in the selection control 503, “dining room” can be selected for the switch and serve as a deploying position selected for the smart device selected in the scene, the selection operation of the user is regarded as a position selection operation; in the selection control 504, “turning off” can be selected for the switch and serve as a scene action selected for the smart device selected in the scene; if the user clicks the “next” control 505, it is represented that the user confirms that the scene action in the scene completes configuration, the clicking operation of the user is regarded as an action confirming operation. Based on at least one of the aforesaid operations, it is possible to trigger generating an action configuration instruction, confirm that a scene action executed in the scene by the smart device “switch” deployed in “dining room” and connected with a light is “turning off”, and display it, i.e., “turning off a dining room light” in the scene configuration page 401.

Step 270, in response to a scene selection operation for a target scene, jumping from the scene display page to a scene detail page of the target scene.

In FIG. 3, if a user clicks a scene 305 represented by the scene identifier “turning off all lights”, it is represented that the user selects the scene 305 as a target scene. At this time, the scene display page 301 jumps to a scene detail page 601 of the scene 305, i.e., “turning off all lights”, and the scene detail page 601 displays at least a scene action executed in the scene 305 by at least one smart device, for example, a living room light executes turning off, i.e., “turning off the living room light” 602 in the scene 305; a dining room light executes turning off, i.e., “turning off the dining room light” 603 in the scene 305, and so on. Among them, a clicking operation of the user is regarded as a scene selection operation for the target scene. At the same time, the scene detail page 601 further displays a scene execution entrance 605, which provides a function of scene one-click execution for the user, so as to indicate at least one smart device to execute a corresponding scene action in the scene. For example, if the user clicks the scene execution entrance 603, it is considered as one-click execution of the scene action “turning off all lights”, thus the living room light and the dining room light are turned off correspondingly, thereby realizing controlled execution of the scene action “turning off all lights”.

Similarly, in the scene configuration page 401 and the scene detail page 601, it is also possible to form an action configuration operation through the control 603 and the action adding entrance 604, so as to add/modify a scene action executed by a smart device in a scene based on the action configuration operation. Of course, in other embodiments, the scene configuration page and the scene detail page can also be combined into the same page based on use experience of a user, which does not form specific limitation here.

It should be additionally noted that besides the controlled execution scene shown in FIG. 3, there is also an automated scene in the constructed scenes in the user terminal, its construction process is basically the same as the construction process of the controlled execution scene. The difference is that in the automated scene, in addition to the need of configuring relevant scene actions, a relevant triggering condition also needs to be configured. That is to say, the controlled execution scene refers to the smart device that has performed scene action configuration in the controlled execution scene executes a corresponding scene action only when the user clicks the scene execution entrance; while the automated scene refers to that the smart device that has performed scene action configuration in the automated scenario will automatically execute a corresponding scene action if the triggering condition configured in the automated scene is met.

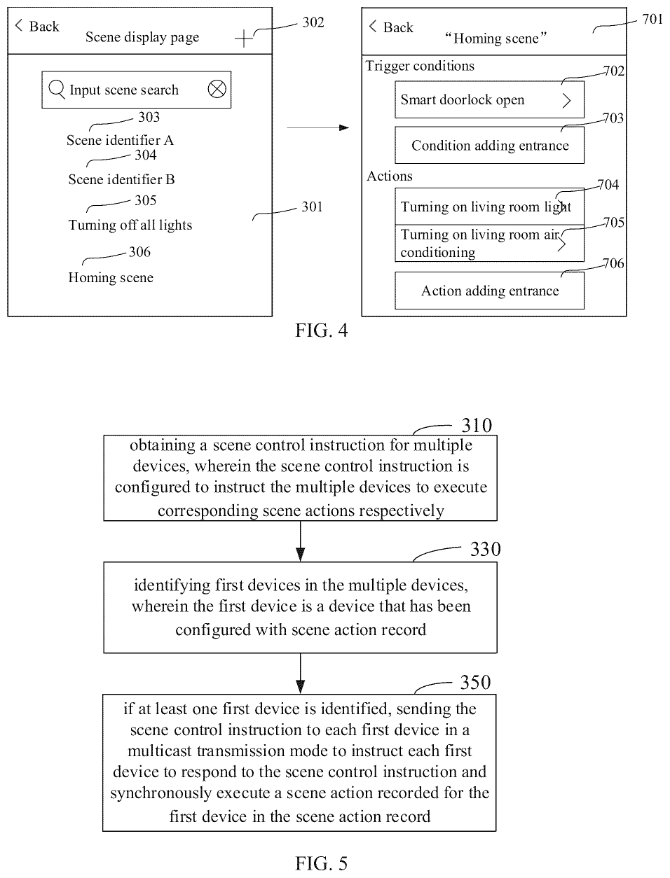

Now, with reference to FIG. 4, taking the automated scene being a homing scene as an example, the triggering condition in the automated scene differing from the controlled execution scenario are explained in detail as follows.

As shown in FIG. 4, assuming that an automated scene 306 has been constructed and displayed in the scene display page 301 through a scene identifier “homing scene”, thus when a user clicks the scene identifier, a scene detail page 701 of the automated scene 306 can be entered. In the scene detail page 701, the displayed triggering condition is: opening a smart doorlock; and the displayed scene actions are: turning on a living room light, and turning on a living room air conditioning. A condition adding entrance 703 used to add triggering conditions and an action adding entrance 706 used to add scene actions are further displayed. In addition, modifying triggering conditions can be implemented through a control 702, and modifying scene actions can be implemented through the controls 704, 705. Based on this, with construction of the automated scene 306, when a user returns home and make the smart doorlock open, it is considered that the triggering condition configured in the automated scene 306 is met. At this time, the living room light and the living room air conditioning configured with scene actions in the automated scene 306 will automatically execute corresponding scene actions, that is, automatically turning on the living room light and automatically turning on the living room air conditioning, thereby realizing automatic execution for the homing scene.

It is worth mentioning that specific behaviors of the aforesaid operations may vary depending on different input components (e.g., a touch layer covering on a display screen, a mouse, a keyboard, and the like) configured by the user terminal. For example, if the user terminal is a smartphone with a touch layer configured, the above operations can be gesture operations such as clicking, sliding, and so on; for a user terminal being a laptop with a mouse configured, the above operations can be mechanical operations such as drag and drop, click, double-click, etc., which are not limited here. From this, it can be seen that as scenes are constructed in the user terminal, users can use the controlled execution scene or the automated scene constructed in the user terminal to control multiple devices to execute multiple actions.

A device control process specifically refers to: as shown in FIG. 5, step 310, obtaining a scene control instruction for multiple devices, wherein the scene control instruction is configured to instruct the multiple devices to execute corresponding scene actions respectively; step 330, identifying first devices in the multiple devices, wherein the first device is a device that has been configured with scene action record; step 350, if at least one first device is identified, sending the scene control instruction to each first device in a multicast transmission mode to instruct each first device to respond to the scene control instruction and synchronously execute a scene action recorded for the first device in the scene action record.

In the above process, synchronously controlling multiple devices to execute multiple actions based on one scene control instruction is realized, it is avoided that multiple smart devices are controlled one by one based on multiple instructions, that is, it is avoided that multiple smart devices execute corresponding set actions sequentially, thus network latency of multiple devices executing multiple actions is reduced, so that the problem of significant network latency of multiple devices executing multiple actions existing in the related art can be effectively solved.

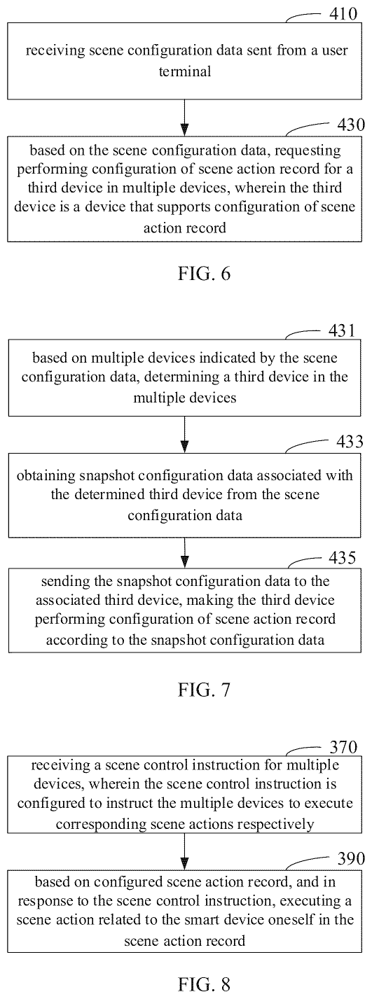

Now, with reference to FIG. 6 to FIG. 7, the configuration of the scene action record in the device control process will be first explained in detail below, taking application of this configuration process to an electronic device as an example to explain. Among them, the electronic device can be the gateway 150 in FIG. 1, and can also be the server end 170, the user terminal 110, and so on in FIG. 1, which are not specifically limited here.

As shown in FIG. 6, a configuration process of the scene action record can include the following steps.

Step 410, receiving scene configuration data sent from a user terminal.

Among them, the scene configuration data is generated when a scene is constructed in the user terminal, the scene configuration data indicates at least scene actions which are configured to be allowed to be executed by multiple devices.

It should be understood that with different scenes, even the same smart device (hereinafter referred to as the device) may have different scene actions that are configured to be allowed to be executed. For example, if the scene is a main bedroom, when the owner is sleeping, a smart fan is turned on; if the scene is a bathroom, when the owner leaves, the smart fan will turn off. Therefore, the scene actions configured to be executed for the device are on the premise of the scene, when the scene varies, the scene configuration data also varies. For example, scene configuration data A corresponds to a controlled execution scene, the scene configuration data A is used to indicate scene actions that are configured to be allowed to be executed by multiple devices in the controlled execution scenario; scene configuration data B corresponds to an automated scene, the scene configuration data B is used to indicate triggering conditions configured in the automated scene, that is, indicate device statuses when multiple devices meet the triggering conditions in the automated scene, and is also used to indicate scene actions that are configured to be allowed to be executed by multiple devices in the automated scene.

In a possible implementation, the scene configuration data includes at least a scene identifier of a scene, a device identifier of at least one device, and an action identifier of a scene action corresponding to a device.

Step 430, based on the scene configuration data, requesting performing configuration of scene action record for a third device in multiple devices.

Among them, a third device is a device that supports configuration of scene action record. Correspondingly, a first device is a device that has completed configuration; a second device is a device that does not support configuration of scene action record, that is, a device that has not performed configuration.

Scene action record refers to record of scene actions that are configured

to be allowed to executed by a device in a scene. That is to say, the scene actions included in a device's configured scene action record, or simply referred to as scene actions recorded by the device, are equivalent to the scene actions that are allowed to be executed by the device. In a possible implementation, a device configured with scene action record indicates that the device has a scene action that is allowed to be executed. Scene action record can be understood as snapshot data for device functions, for example, an executed action supported by the device can be packaged as a snapshot action, and data containing the snapshot action can be scene action record. Correspondingly, configuration of scene action record refers to storing scene action record in the third device, so that the third device knows in advance scene actions that can be executed by itself in the scene.

Specifically, as shown in FIG. 7, step 430 can include the following steps.

Step 431, based on multiple devices indicated by the scene configuration data, determining a third device in the multiple devices.

In a possible implementation, whether a device supports configuration of scene action record is determined through a device identifier, for example, a device identifier of supporting configuration of scene action record is stored in advance in the server end. In a possible implementation, whether a device supports configuration of scene action record is determined through device version information, for example, device version information of supporting configuration of scene action record is stored in advance in the server end. Of course, in other embodiments, whether a device supports configuration of scene action record can also be determined through adding a snapshot identifier, for example, if the server end identifies that a snapshot identifier carried by a device is 1, it is represented that the device supports configuration of scene action record, this does not constitute a specific limitation here.

Step 433, obtaining snapshot configuration data associated with the determined third device from the scene configuration data.

Among them, the snapshot configuration data is used to indicate a scene action that is configured to be allowed to be executed by the third device.

In a possible implementation, the snapshot configuration data includes at least a device identifier of at least one third device, and an action identifier corresponding to a scene action of the third device.

Step 435, sending the snapshot configuration data to the associated third device, making the third device performing configuration of scene action record according to the snapshot configuration data.

Thus, upon completion of the configuration of the scene action record, the third device is transformed into the first device that has completed the configuration.

For example, assuming that in a scene A, a wall switch B1 is turned on (action identifier is C1), a brightness of a light B2 is 50% (action identifier is C2), and a temperature of an air conditioning B3 is 26° C. (action identifier is C3). Among them, the light B2 and the air conditioning B3 support configuration of scene action record, the wall switch B1 does not support configuration of scene action record.

Thus, scene configuration data= {A, B1(C1), B2(C2), B3(C3)}.

The light B2 and the air conditioning B3 are third devices, thus it is obtained that snapshot configuration data associated with the third devices={B2(C2), B3(C3)}.

In a possible implementation, the configuration of the scene action record specifically refers to storing a scene identifier of a scene, a device identifier of a third device, and an action identifier of a scene action into the third device. Taking the aforesaid examples to explain, for the light B2, it stores the action identifier C2 of executing an scene action in the scene A using it; therefore, during a following process of multiple devices executing multiple actions in the scene A, it is possible to execute according to the scene action represented by the pre-stored action identifier C2, which can also be considered as a scene action related to itself in the configured scene action record, that is, adjust the brightness to 50%.

It is worth mentioning that during the process of configuration of the scene action record, in a possible implementation, the gateway can send parts in snapshot configuration data corresponding to each third device to the third device, for example, the light B2 can only receive the action identifier C2 of executing an scene action in the scene using it, thereby reducing the amount of data transmission between the gateway and the third device and facilitating improvement of transmission efficiency. In another possible implementation, the gateway can also send all parts of snapshot configuration data to each third device. For example, the light B2 can not only receive the action identifier C2 of executing a scene action in the scene using it, but also receive the action identifier C3 of using the air conditioner B3 executing a scene action in the scene, thereby reducing the processing burden on the gateway and facilitating improvement of processing efficiency of the gateway. At this point, the light B2 needs to further perform configuration of scene action record in combination of its own device identifier B2, so that it can execute scene actions related to itself in the scene action record in the future, which are not limited here.

In the above process, configuration related to scene action record of devices is implemented, so that the devices quickly execute scene actions related to themselves based on configured scene action record the scene action record in the future.

In a possible implementation, a device control method is provided, the method is applied in an electronic device, such as the smart device 130 in FIG. 1. As shown in FIG. 8, the device control method can include the following steps: step 370, receiving a scene control instruction for multiple devices, wherein the scene control instruction is configured to instruct the multiple devices to execute corresponding scene actions respectively; step 390, based on configured scene action record, and in response to the scene control instruction, executing a scene action related to the smart device oneself in the scene action record. In a possible implementation, taking the method being executed by a device control system and implemented through interaction between a server end and smart devices as an example to explain; wherein the server end includes but is not limited to the gateway 150 and the server end 170 shown in FIG. 1, and the smart device can be the smart device 130 in FIG. 1; correspondingly, the device control method can include the following steps: the server end obtaining a scene control instruction for multiple smart devices, and in a case that at least one first device is identified from the smart devices, sending the scene control instruction to the first devices in a multicast transmission mode, wherein the scene control instruction is configured to instruct the smart devices to execute corresponding scene actions respectively, and the first device is a smart device that has been configured with scene action record; the first devices, in response to the received scene control instruction, based on the configured scene action record, executing scene actions related to themselves in the scene action record. Thus, sending one piece of instruction by a server end (e.g., a gateway) can synchronously control multiple devices to execute multiple actions, thereby facilitating solving the problem of significant network latency of multiple devices executing multiple actions existing in the related art.

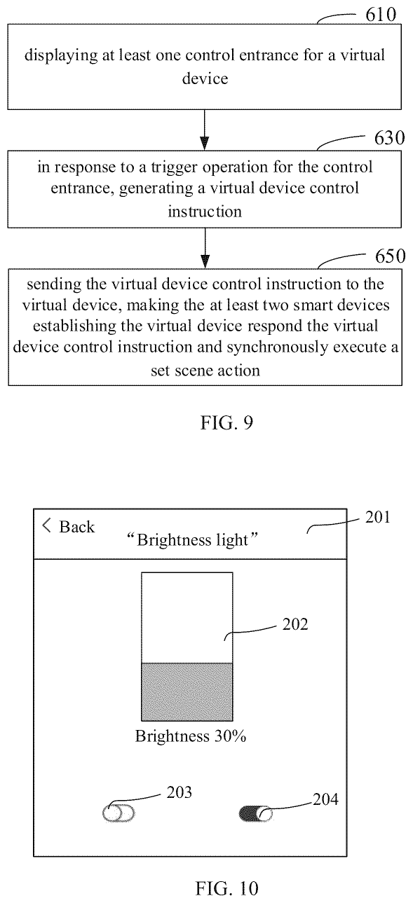

In another possible implementation, referring to FIG. 9, a device control method is provided, this method is applicable to a user terminal, such as the user terminal 110 in the implementation environment shown in FIG. 1. Additionally, since many existing smart devices are also provided with user interfaces similar to that of user terminals, such as smartphones, and can be used to display information and input instructions, in some embodiments, the device control method can also be applied in the aforesaid smart device 130, as long as the smart device 130 has a user interface that can be used to implement specific steps thereof.

As shown in FIG. 9, the method can include the following steps.

Step 610, displaying at least one control entrance for a virtual device.

Firstly, it should be noted that the virtual device is established by at least two smart devices that are allowed to execute at least one identical scene action.

For example, there are two smart devices deployed in a bathroom: a smart fan and a smart light. When entering the bathroom, the smart fan and smart light are turned on at the same time; and when leaving the bathroom, the smart fan and smart light are turned off at the same time. From this, it can be seen that scene actions allowed to be executed by the smart fan and the smart light remain the same in this smart home scene. Therefore, in order to reduce network delay of the smart fan and the smart light executing actions, both the smart fan and the smart light can be defined as first devices and jointly created as a virtual device, so that the smart fan and the smart light can synchronously execute scene actions such as turning on or turning off.

Secondly, the control entrance is used to control the at least two smart devices establishing the virtual device to synchronously execute set scene actions. In a possible implementation, the at least one control entrance for the virtual device is displayed on a device detail page of the virtual device.

For at least one control entrance of the virtual device, in a possible implementation, each control entrance corresponds to a set scene action, so that the at least two smart device establishing the virtual device synchronously execute a set scene action corresponding to a control entrance. In a possible implementation, set scene actions corresponding to different control entrances have different scene action types, so that the at least two smart device establishing the virtual device synchronously execute a set scene action matching a scene action type supported by themselves, wherein the scene action type supported by the smart device themselves is used to indicate a scene action that is allowed to be executed by the smart devices.

FIG. 10 shows a schematic diagram of a device detail page of a virtual device in an embodiment, as shown in FIG. 10, in a device detail page 201 of a virtual device “brightness light”, at least three control entrances are displayed, they are respectively a brightness control entrance 202, an ON control entrance 203, and an OFF control entrance 204. Assuming that the virtual device “brightness light” is established by four smart devices: two switches and two smart lights electrically connected with the two switches, the brightness control entrance 202 is used to control the two smart lights to synchronously execute a brightness adjustment action, the ON control entrance 203 is used to control the two switches and the two smart lights to synchronously execute a turning-on action, and the OFF control entrance 204 is used to control the two switches and the two smart lights to synchronously execute a turning-off action. From this, it can be seen that in the smart home scene, a set scene action corresponding to the brightness control entrance 202 is the brightness adjustment action, a set scene action corresponding to the ON control entrance 203 is the turning-on action, and a set scene action corresponding to the OFF control entrance 204 is the turning-off action. For the four smart devices establishing the virtual device, action types supported by the switches include opening and closing, indicating that actions allowed to be executed by the switches include actions such as opening and closing; action types supported by the smart lights include opening, closing, and adjusting brightness, indicating that actions allowed to be executed by the smart lights include actions such as opening, closing, and adjusting brightness. It can also be considered that set actions that match the action types supported by the switches themselves include actions such as opening and closing, and set actions that match the action types supported by the smart light themselves include actions such as opening, closing, and adjusting brightness.

Step 630, in response to a trigger operation for the control entrance, generating a virtual device control instruction.

Among them, the virtual device control instruction is used to instruct the virtual device to execute a set scene action corresponding to the control entrance, the set scene action belongs to scene actions that are allowed to be executed by at least two smart devices establishing the virtual device.

Still taking the virtual device “brightness light” as an example to explain, scene actions that are allowed to be executed by the four smart devices establishing the virtual device include scene actions such as turning on, turning off, and adjusting brightness, correspondingly, the set scene actions corresponding to the control entrance include scene actions such as turning on, turning off, and adjusting brightness. From this, if a trigger operation for the ON control entrance 203 is responded, a virtual device control instruction used to control the virtual device to execute a turning-on action is generated; if a trigger operation for the OFF control entrance 204 is responded, a virtual device control instruction used to control the virtual device to execute a turning-off action is generated; if a trigger operation for the brightness control entrance 202 is responded, a virtual device control instruction used to control the virtual device to execute a brightness adjustment action is generated.

Step 650, sending the virtual device control instruction to the virtual device, making the at least two smart devices establishing the virtual device respond the virtual device control instruction and synchronously execute a set scene action.

With reference to the implementation environment shown in FIG. 1, a process of transmission of the virtual device control instruction among the user terminal 110, the gateway 150, and the smart device 130 is explained below.

With respect to the gateway 150, after the user terminal 110 sends a virtual device control instruction to the virtual device, the virtual device control instruction can be received, and thus the virtual device control instruction is sent to the at least two smart devices 130 establishing the virtual device according to a multicast transmission mode. From this, for the smart devices 130 establishing the virtual device, if the virtual device control instruction sent from the gateway 150 is received, in response to the virtual device control instruction, a set scene action is synchronously executed.

Continuing to take the virtual device “brightness light” as an example to explain, for the four smart devices establishing the virtual device, if a virtual device control instruction used to control the virtual device to execute the turning-on action, which is sent from the gateway 150, is received, the two switches synchronously execute the turning-on action, at the same time, the two smart lights synchronously execute the turning-on action; if a virtual device control instruction used to control the virtual device to execute the turning-off action, which is sent from the gateway 150, is received, the two switches synchronously execute the turning-off action, at the same time, the two smart lights synchronously execute the turning-off action; if a virtual device control instruction used to control the virtual device to execute the brightness adjustment action, which is sent from the gateway 150, is received, the two smart lights synchronously execute the brightness adjustment action. It should be noted here that since the action types supported by the switches themselves include turning-on and turning-off, the switches only execute the set scene actions matching the action types supported by the themselves, that is, the actions such as turning-on and turning-off.

Through the above process, unified and rapid control of multiple devices has been achieved, that is, at least two smart devices allowed to execute at least one identical action can establish a virtual device, by controlling the virtual device to execute a set scene action, essentially controlling the at least two smart devices to synchronously execute the set scene action, the at least two smart devices are avoided from sequentially executing the set scene action; network latency of multiple devices executing actions is thereby reduced, and thus the problem of significant network latency of multiple devices executing actions existing in the related art can be effectively solved.

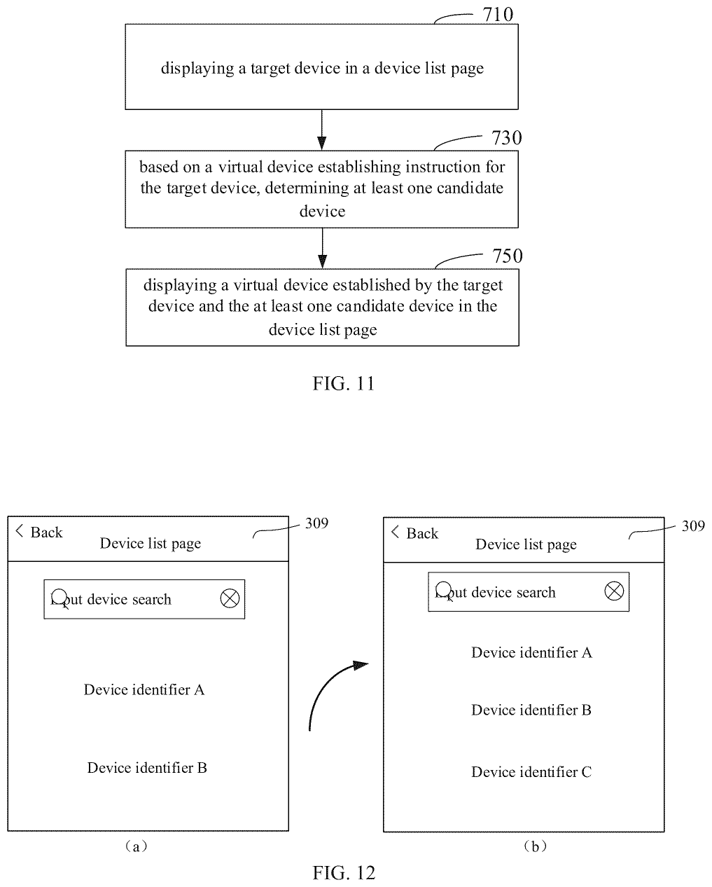

FIG. 11 shows a method flowchart of a virtual device establishing process in an embodiment, as shown in FIG. 11, the method can include the following steps.

Step 710, displaying a target device in a device list page.

Among them, the device list page is used to show multiple smart devices deployed in a gateway, which include but are not limited to target devices. It should be noted here that the smart devices are uniquely represented by device identifiers, for example, the smart device A is uniquely represented by a device identifier A, so that in the device list page, by displaying the device identifier A, it is represented that the smart device A deployed in the gateway is displayed in the device list page.

FIG. 12(a) shows a schematic diagram of displaying smart devices in an embodiment, as shown in FIG. 12(a), in a device list page 309, a device identifier A and a device identifier B are displayed, they respectively represent a smart device A and a smart device B deployed in a gateway, wherein the smart device A is a target device.

Step 730, based on a virtual device establishing instruction for the target device, determining at least one candidate device.

Among them, the candidate device refers to a smart device of which at least one scene action allowed to be executed is the same as scene actions executed by the target device.

In a possible implementation, the candidate device is randomly selected by a user. Specifically, based on the virtual device establishing instruction for the target device, it is prompted that the candidate device is selected from multiple smart devices displayed on the device list page, and in response to a selection operation for at least one smart device in the multiple smart devices, the selected smart device is selected as the candidate device. That is to say, the candidate device that can jointly establish the virtual device with the target device can be randomly selected by the user to enhance flexibility of establishing the virtual device and thus facilitate improvement of flexibility of device control.

In a possible implementation, the candidate device is recommended by the gateway/server end, specifically based on the virtual device establishing instruction for the target device, the gateway/server end is requested to acquire device recommendation data. Among them, the device recommendation data is used to indicate at least one recommended device, the recommended device refers to a smart device of which at least one scene action allowed to be executed is the same as a scene action executed by the target device; at least one candidate device is determined based on the device recommendation data returned by the gateway/server end. Among them, the method of determining at least one candidate device based on the device recommendation data returned by the gateway/server end can be random selection by the user terminal, and can also be random selection by the user, which is not limited here. In this implementation, the candidate device that jointly establishes the virtual device with the target device can be recommended by the gateway/server end based on historical scene data to ensure accuracy of determining the candidate device, thereby improving accuracy of establishing the virtual device and further facilitating improvement of the success rate of device control.

For example, there are a smart fan and a smart light deployed in a bathroom, and scene actions executed by the smart fan and smart light are the same. Thus, if the smart fan is the target device, for the gateway/server end, based on historical scene data, it is possible to determine that a smart device of which an executed scene action is the same as the scene action executed by the smart fan is the smart light, then the smart light is used as a recommended device, and device recommendation data is generated and returned to the user terminal. In a possible implementation, the device recommendation data includes at least a device identifier of at least one recommended device.

After determining at least one candidate device, the virtual device can be established by the target device and the at least one candidate device and displayed in the device list page, that is, a step 750 is executed.

Step 750, displaying a virtual device established by the target device and the at least one candidate device in the device list page.

In a possible implementation, automatically establishing the virtual device based on the target device and the at least one candidate device includes: randomly generating a device identifier for the virtual device, so as to display the virtual device in the device list page. In this implementation, use experience of users is significantly improved, for example, convenience of users' operations is improved.

In a possible implementation, based on the target device and the at least one candidate device, establishing the virtual device is triggered by an operation. The operation includes at least one of the following: a first determining operation used to determine that the virtual device is established by the target device and the at least one candidate device; an input operation used to input a device identifier for the virtual device; a selection operation used to select a deploying position for the virtual device, the deploying position includes but is not limited to a master bedroom, a guest bedroom, a bathroom, a dining room, a living room, a study room, a storage room, a dressing room, a balcony, a kitchen, a corridor, etc.; and a second determining operation used to determine that establishing the virtual device is completed. In this implementation, not only is it convenient for users to configure the device identifier of the virtual device, but it is also convenient for users to configure the deploying position of the virtual device, types of virtual devices are enriched and flexibility of establishing virtual devices is greatly improved, which is conducive to improve use experience of users, such as improving human-machine interaction rate.

After completing establishing the virtual device, the virtual device can be displayed in the device list page. FIG. 12(b) shows a schematic diagram of displaying a virtual device in an embodiment, as shown in FIG. 12(b), the device list page 309 displays multiple smart devices, which specifically include: a smart device A represented by a device identifier A, a smart device B represented by a device identifier B, and a virtual device C represented by a device identifier C.

Through the above process, establishing of the virtual device is realized, that is, multiple smart devices that are allowed to execute at least one identical scene action are established to be a virtual device, by controlling the virtual device to execute a set scene action, essentially controlling the multiple smart devices to synchronously execute the set scene action, the multiple smart devices are avoided from sequentially executing the set scene action; network latency of multiple devices executing actions is thereby reduced, and thus the problem of significant network latency of multiple devices executing actions existing in the related art can be effectively solved.

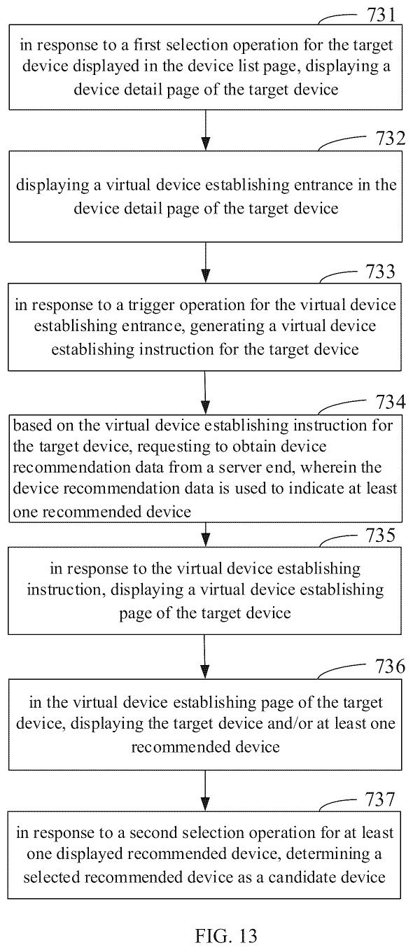

Referring to FIG. 13, in an exemplary embodiment, the step 730 can include the followings steps.

Step 731, in response to a first selection operation for the target device displayed in the device list page, displaying a device detail page of the target device.

In a possible implementation, the device list page is jumped to the device detail page of the target device to display the device detail page of the target device; in a possible implementation, the device detail page of the target device is displayed in the device list page.

Step 732, displaying a virtual device establishing entrance in the device detail page of the target device.

Of course, in other possible implementations, at least one of following device details of the target device can also be displayed in the device detail page of the target device: a device state of the target device; a control entrance used to control the target device to execute a set scene action.

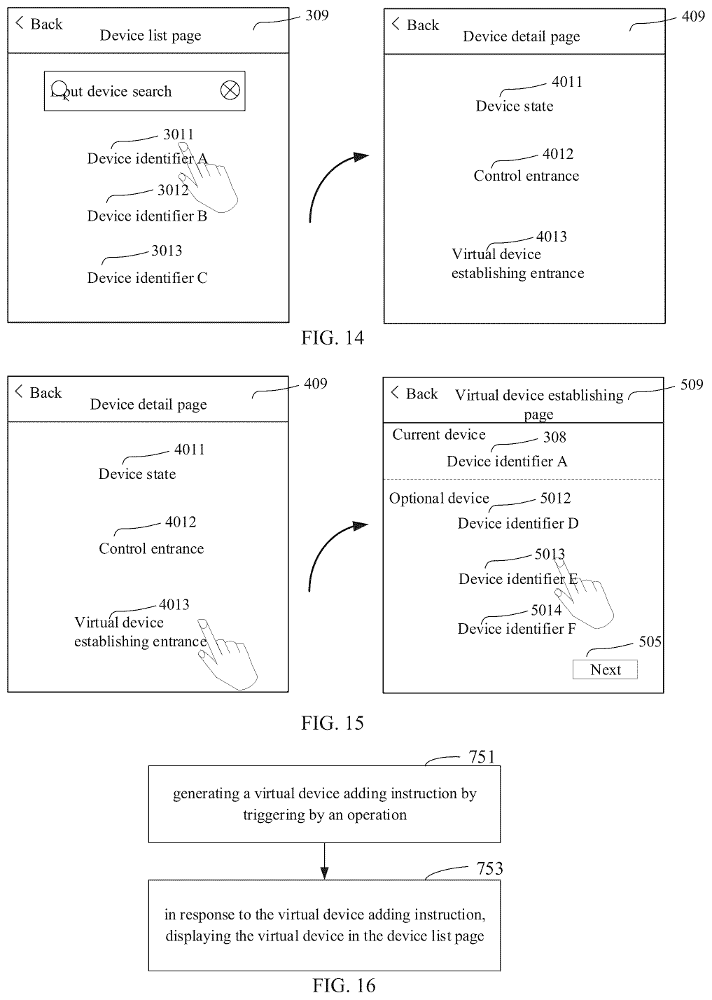

FIG. 14 shows a schematic diagram of a device detail page of a target device and a jumping process thereof in an embodiment. As shown in FIG. 14, in the device list page 309, if a user clicks the device identifier A, it is represented that the user selects the smart device 308 as the target device. At this time, the device list page 309 is jumped to the device detail page 409 of the smart device 308. Among them, the clicking operation of the user is the first selection operation for the target device.

It is worth mentioning that specific behaviors of the first selection operation may vary depending on different input components (e.g., a touch layer covering on a display screen, a mouse, a keyboard, and the like) configured by the electronic device. For example, if the electronic device is a smartphone with a touch layer configured, the first selection operation can be gesture operations such as clicking, sliding, and so on; for an electronic device being a laptop with a mouse configured, the first selection operation can be mechanical operations such as drag and drop, click, double-click, etc., which are not limited in this embodiment.

In FIG. 14, the device detail page 409 of the smart device 308 displays at least: a device state 4011 of the smart device 308, a control entrance 4012 of the smart device 308, and a virtual device establishing entrance 4013 of the smart device 308. Among them, the device state 4011 is used to represent a current device state of the smart device 308, the control entrance 4012 is used to instruct the smart device 308 to execute a set scene action, and the virtual device establishing entrance 4013 is used to establish a virtual device.

Step 733, in response to a trigger operation for the virtual device establishing entrance, generating a virtual device establishing instruction for the target device.

Step 734, based on the virtual device establishing instruction for the target device, requesting to obtain device recommendation data from a server end.

Among them, the device recommendation data is used to indicate at least one recommended device, the recommended device refers to a smart device allowed to execute at least one scene action identical to that of the target device.

Step 735, in response to the virtual device establishing instruction, displaying a virtual device establishing page of the target device.

Step 736, in the virtual device establishing page of the target device, displaying the target device and/or at least one recommended device indicated by the device recommendation data. In a possible implementation, at least one recommended device is displayed in the virtual device establishing page of the target device. In a possible implementation, the target device and at least one recommended device is displayed in the virtual device establishing page of the target device.

FIG. 15 shows a schematic diagram of a virtual device establishing page of a target device and a jumping process thereof in an embodiment. As shown in FIG. 15, in the device detail page 409 of the target device, if a user clicks the virtual device establishing entrance 4013, a virtual device establishing instruction is generated, thereby requesting device recommendation data from a server end. In a possible implementation, the device recommendation data includes at least a device identifier of at least one recommended device. For example, in FIG. 15, the device identifier A represents the target device 308, the device identifier D represents a recommended device 5012, the device identifier E represents a recommended device 5013, the device identifier F represents a recommended device 5014. Among them, the clicking operation of the user is the trigger operation for the virtual device establishing entrance.

Optionally, in FIG. 16, in response to the virtual device establishing instruction, the device detail page 409 of the target device is jumped to a virtual device establishing page 509, and the target device 308, the recommended device 5012, the recommended device 5013, and the recommended device 5014, which are respectively represented by the device identifiers A, D, E, F, are displayed in the virtual device establishing page 509.

Of course, in other embodiments, the at least one recommended device indicated by the device recommendation data can also be still displayed in the device detail page of the target device, for example, displayed in a blank area below the virtual device establishing entrance, which does not form specific limitation here.

Step 737, in response to a second selection operation for at least one displayed recommended device, determining a selected recommended device as a candidate device.

Continuing referring to FIG. 15, if a user clicks the device identifier E, it is represented that the user selects the recommended device 5013 as a candidate device. Among them, the clicking operation of the user is the second selection operation for at least one displayed recommended device.

Through cooperation of above embodiments, in combination with manners of recommendation by the gateway/server end and random selection by users, determination of a candidate device is realized. It is ensured that the candidate device jointly establishing the virtual device with the target device is not only from recommended devices recommended by the gateway/server, which ensures accuracy of determining the candidate device and improves accuracy of establishing the virtual device, but also met by selection of users, which improves flexibility of establishing the virtual device. Thus, it is conducive to improve success rate and flexibility of controlling the devices, and finally conducive to ensure stability of controlling the devices.

Referring to FIG. 16, in an exemplary embodiment, the step 750 can include the following steps.

Step 751, generating a virtual device adding instruction by triggering by an operation.

Among them, the operation includes at least one of the following: a first determining operation used to determine that the virtual device is established by the target device and at least one candidate device; an input operation used to input a device identifier for the virtual device; a third selection operation used to select a deploying position for the virtual device; and a second determining operation used to determine completion of establishing the virtual device.

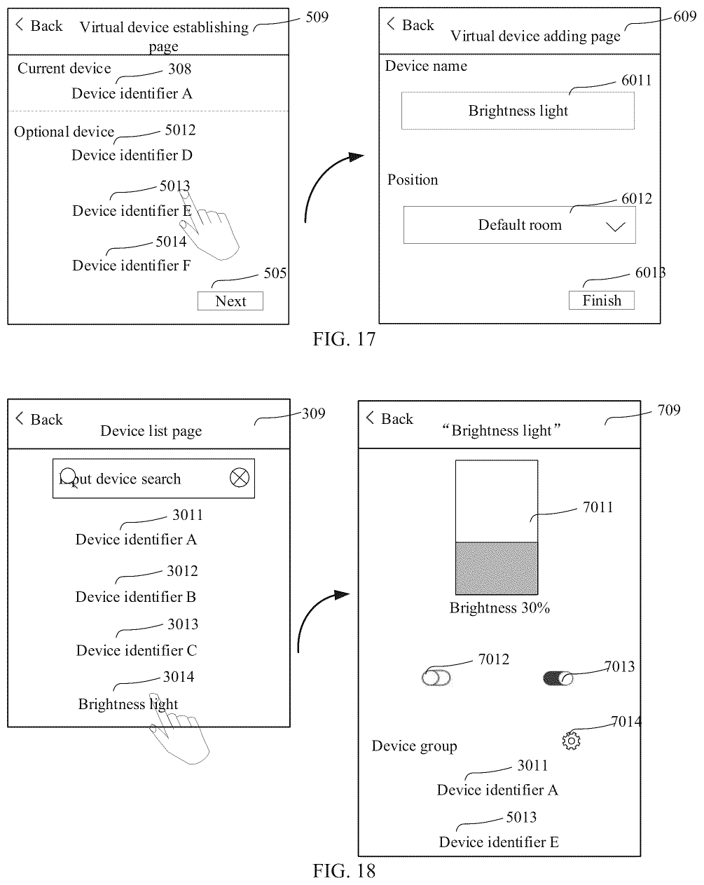

FIG. 17 shows a schematic diagram of adding a virtual device in an embodiment. In FIG. 17, if a user clicks the device identifier E, it is represented that the user selects the candidate device 5013 as a candidate device. Optionally, if a user clicks the “next” control 505, it is represented that the user determines that the virtual device is established by the target device 308 represented by the device identifier A and the candidate device 5013, that is, the determining operation of the user is regarded as the first determining operation.

In a possible implementation, in response to the first determining operation, a virtual device adding instruction is generated, so as to display a virtual device in the device list page. In this implementation, both the device identifier and the deploying position of the virtual device are randomly generated by the electronic device, excessive manual operations of the user are avoided, which is conducive to improve operation convenience of the user, and thus is conducive to improve use experience of the user.

In a possible implementation, in response to the first determining operation, the virtual device establishing page is jumped to the virtual device adding page, so as to generate a virtual device adding instruction based on an operation triggered in the virtual device adding page. Also referring to FIG. 17, in the input control 608, it is possible to input “brightness light” for a virtual device as a device identifier of the virtual device, this input operation of the user is regarded as the input operation; in the selection control 6012, it is possible to select “default room” (e.g., a system default living room) for the virtual device as a deploying position of the virtual device, the selection operation of the user is regarded as the third selection operation; if the user clicks the “finish” control 6013, it is represented that the user determines completion of establishing the virtual device, that is, the clicking operation of the user is regarded as the second determining operation. Based on at least one of the above operations, the virtual device adding instruction can be generated.

Step 753, in response to the virtual device adding instruction, displaying the virtual device in the device list page.

FIG. 18 shows a schematic diagram about a page jumping process of a virtual device in an embodiment. As shown in FIG. 18, a virtual device 3014 represented by a device identifier “brightness light” is displayed in the device list page 309.

When the device list page displays the virtual device, at least one control entrance for the virtual device can be further displayed. In a possible implementation, at least one control entrance for the virtual device is displayed in the device list page. In a possible implementation, at least one control entrance for the virtual device is displayed in the display detail page of the virtual device; specifically, in response to a third selection operation for the virtual device displayed in the device list page, the device detail page of the virtual device is displayed, and at least one control entrance is displayed in the device detail page of the virtual device.

Of course, in other embodiments, the device detail page of the virtual device can display at least one of the following device details of the virtual device: the device state of the virtual device; the target device and the at least one candidate device that establish the virtual device; the virtual device establishing entrance used to establish virtual devices; and a control entrance used to control the at least two smart devices that establish the virtual device to synchronously execute set scene actions.

Continuing taking the aforesaid virtual device “brightness light” as an example to explain, as shown in FIG. 18, in the device list page 309, the device identifier “brightness light” represents a virtual device 3014, that is, a virtual device “brightness light”; after a user clicks the device identifier “brightness light”, the device list page 309 is jumped to the device detail page 709 of the virtual device “brightness light”, the device detail page 709 displays a brightness control entrance 7011, an ON control entrance 7012, an OFF control entrance 7013, and a virtual device establishing entrance 7014. For example, when a user desires adding a smart light to join establishment of the virtual device “brightness light”, or a user desires adjusting a deploying position of the virtual device “brightness light”, the virtual device establishing entrance 7014 can be clicked. Furthermore, the device detail page 709 of the virtual device “brightness light” further displays the smart devices that establish the virtual device “brightness light”, which specifically include the smart light 308 represented by the device identifier A and the smart switch 5013 represented by the device identifier E.

Under action of the above embodiments, it is realized that establishment of the virtual device is triggered based on operations, not only is it convenient for users to configure the device identifier of the virtual device, but it is also convenient for users to configure the deploying position of the virtual device, types of virtual devices are enriched and flexibility of establishing virtual devices is greatly improved, which is conducive to improve use experience of users, such as improving human-machine interaction rate. An application scene involved by an embodiment of the present disclosure is now introduced with reference to an implementation environment involved by embodiments of the present disclosure.

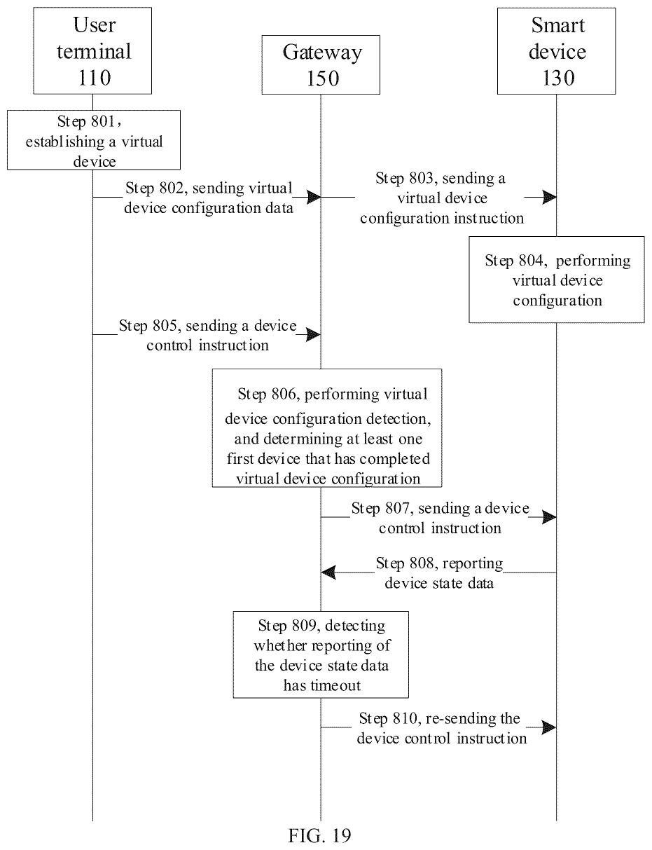

As shown in FIG. 19, in an application scene, a process of implementing device control among the user terminal 110, the gateway 150, and the smart device 130 can include the following steps.

Step 801, the user terminal 110 determining at least one candidate device based on a virtual device establishing instruction for a target device, and establishing a virtual device by the target device and the at least one candidate device.

Step 802, sending virtual device configuration data to the gateway 150.

Step 803, the gateway 150 generating a virtual device configuration instruction based on the virtual device configuration data and sending it to the smart device 130.

Step 804, the smart device 130 performing virtual device configuration in response to the virtual device configuration instruction.

Among them, the virtual device configuration data is used to indicate that the virtual device is established by the target device and the at least one candidate device. In a possible implementation, the virtual device configuration data includes at least a device identifier of the virtual device, a device identifier of the target device, and a device identifier of at least one candidate device.

Therefore, with respect to the gateway 150, based on the virtual device configuration data, the target device and the at least one candidate device that establish the virtual device can be determined, thus the virtual device configuration instruction can be generated and sent to corresponding smart devices 130, that is, the target device and the at least one candidate device. In a possible implementation, the virtual device configuration instruction includes at least a device identifier of the virtual device.

With respect to the smart device 130, after receiving the virtual device configuration instruction, it is possible to perform virtual device configuration in response to the virtual device configuration instruction. In a possible implementation, the virtual device configuration refers to storing a device identifier of the virtual device. For example, a smart device B stores a device identifier A of a virtual device A, thus the smart device B knows that it joints establishment of the virtual device A; afterwards,, when controlling the virtual device A to execute a set scene action, the smart device B will synchronously execute the set scene action with other smart devices that join establishment of the virtual device A.

Accordingly, after completing virtual device configuration relating to the virtual device in the smart device 130, it is possible to control the smart device 130 through controlling the virtual device, which specifically includes the following steps.

Step 805, the gateway 150 receives a device control instruction sent from the user terminal 110.

In a possible implementation, the device control instruction includes at least a device identifier of a virtual device and an action identifier of a set scene action.

Step 806, based on the device control instruction, performing virtual device configuration detection for a target device and at least one candidate device that establish the virtual device, and determining at least one first device that has completed virtual device configuration.

In a possible implementation, virtual device configuration detection refers to determine whether a smart device stores a device identifier of a virtual device. For example, that the gateway 150 performs virtual device configuration detection for the smart device B includes that: the gateway 150 sends a virtual device configuration detection request to a smart device B; in response to the virtual device configuration detection request, the smart device B returns a corresponding request response to the gateway 150, wherein the request response carries a device identifier A of a virtual device A. At this time, the gateway 150 can determine that the smart device B has completed virtual device configuration relating to the virtual device A.

Smart devices 130 that have completed virtual device configuration are used as first devices, and a step 807 is executed.

Smart device 130 that have not completed virtual device configuration are used as second devices, and the following step is executed: a device control instruction is independently sent to each second device according to a unicast transmission mode, such that each second device responds to the device control instruction and executes a set scene action.

Step 807, using at least one first device as a multicast member, sending a device control instruction to the multicast member, such that each multicast member responds to the device control instruction and synchronously execute a set scene action.

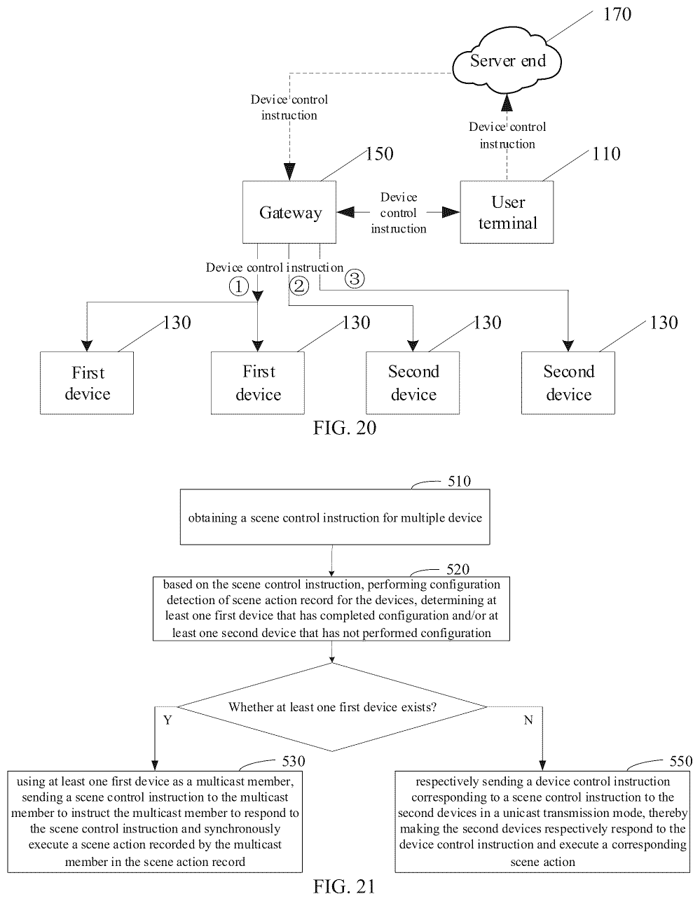

FIG. 20 shows a schematic diagram of a gateway sending device control instructions to a first device and a second device respectively. In FIG. 20, since the two first devices have completed virtual device configuration, that is, the two first devices have joined establishment of a virtual device, for the two first devices, the essence is executing control through one device control instruction (instruction \textcircled{1} according to the multicast transmission mode, thereby realizing that the two first devices synchronously execute a set scene action; since the two second devices have not completed virtual device configuration, for the two second devices, the gateway 150 successively sends two device control instructions (instruction \textcircled{2} and instruction \textcircled{3}) to the two second devices according to the unicast transmission mode, such that the two second devices sequentially execute a set scene action according to a sequence of receiving the device control instructions.

Step 808, the gateway 150 receiving device state data reported by multicast members.

Among them, the device state data is generated after the multicast members execute set scene actions, and is used to indicate device states of the multicast members after executing set scene actions. For example, a smart fan and a smart light are deployed in a bathroom, if the smart fan executes a turning-off action, the device state data is used to indicate that a device state of the smart fan is OFF; or if the smart light executes a turning-on action, the device state data is used to indicate that a device state of the smart light is ON.

Step 809, detecting whether reporting of the device state data has timeout.

If it is detected that reporting of the device state data of at least one multicast member has timeout, the step 810 is executed. On the contrary, if it is detected that reporting of the device state data of each multicast member has no timeout, it is determined that all multicast members have synchronously executed a set scene action.

Step 810, re-sending the device control instruction to the multicast members.

In a possible implementation, the device control instruction is re-sent to all multicast members. In a possible implementation, the device control instruction is re-sent to multicast members of which reporting has timeout, until it is determined that all multicast members returns the device state data in time, that is, it is determined that all multicast members has synchronously executed the set scene action. In this method, not only can success rate of executing the scene action be ensured to the maximum extent, thereby ensuring success rate of controlling the devices, but also stability of controlling the devices can be ensured sufficiently.

It should be noted that for each multicast member, some multicast members may have already executed the set scene action, and reporting of the device state data thereof has no timeout, thus these multicast members can ignore a re-received device control instruction. However, for multicast members which have not executed the set scene action or of which reporting of the device state data has timeout, it is needed to respond the re-received device control instruction again and re-execute the set scene action.

During the above process, with respect to the second devices that do not join establishment of the virtual device, device control is not improved, the gateway still needs to sequentially sent multiple instructions to control multiple smart devices one by one; with respect to the first device that join establishment of the virtual device, device control is greatly improved, that is, the gateway only needs to send one instruction, multiple smart devices can be synchronously controlled. For example, the multiple smart devices that establish the virtual device are controlled to synchronously execute the turning-on action, or the multiple smart devices that establish the virtual device are controlled to synchronously execute the brightness adjustment action, and so on, so that multiple smart devices are avoided from sequentially executing a set scene action according to an instruction reception sequence, both responsiveness for instructions and success rate of controlling multiple devices have significant improvement. Furthermore, with increase of the number of the smart devices, it is more conducive to reduce network latency of multiple devices executing scene actions, thereby achieving effect of simultaneously and quickly controlling multiple devices, which is conducive to greatly improve users' use experience, for example, a user desires multiple smart devices to act uniformly, rather than to act sequentially.

Optionally, the process of implementing device control among the user terminal 110, the gateway 150, and the smart device 130, after the step 810, can further include the following step.

Based on a device control instruction, performing virtual device marking process for at least two smart devices that establish a virtual device, so as to control the at least two smart devices to maintain the same device state when device states of the at least two smart devices are different.

As mentioned above, with respect to the smart fan and the smart light deployed in the bathroom, the smart fan and the smart light execute the same scene action. For example, when entering the bathroom, the smart fan and the smart light are turned on at the same time, and when leaving the bathroom, the smart fan and the smart light are turned off at the same time. However, the inventor realized that the two smart devices mentioned above are not limited to being controlled by a client end associated with the smart devices, but can also be controlled by users' manual operation, or be controlled by other smart devices such as a smart speaker. This may cause scene actions performed by the two smart devices to be asynchronous, thereby affecting control of the two smart devices based on a virtual device. For example, when the device state of the smart fan is ON and the device state of the smart light is OFF, if a user desires to control the virtual device established by the smart fan and the smart light to be turned off, it may result in inability to meet the user's needs.

Therefore, in this embodiment, starting from the gateway level, synchronization of executing a set scene action is achieved for multiple smart devices that establish a virtual device. Specifically, a virtual device marking process is performed for the multiple smart devices that establish a virtual device. Among them, the virtual device marking process is essentially recording that he virtual device is established by a target device and at least one candidate device in the gateway. It can also be considered that in the gateway, the target device and at least one candidate device are “bound” as a virtual device, so that the gateway controls the target device and at least one candidate device to always execute scene actions synchronously and report device state data synchronously.

Still using the aforesaid example to explain, assuming that virtual device A is established by the smart fan and the smart light, as for a client end associated with the smart devices, it can send a device control instruction for instructing the virtual device A to execute a turning-on action to the gateway, so that the gateway controls the smart fan and the smart light to synchronously execute the turning-on action, that is, it is ensured that the smart fan and the smart light are turned on simultaneously.

However, if one of the smart devices is controlled by a user's manual operation, for example, the user manually turns on the smart fan while the smart light remains turned off, this will affect subsequent control of virtual device A. In this regard, the gateway determines that the device state of the smart fan is an ON state and a device state of the smart light is an OFF state based on the device state data reported synchronously by the smart fan and the smart light, and thus understands that the smart fan is turned on and the smart light is turned off. At this time, the gateway will send a device control instruction for instructing the smart light to execute a turning-on action to the smart light, so as to ensure that the smart light and the smart fan can maintain the same device state, that is, to ensure that the smart light and the smart fan synchronously execute a turning-on action.

Of course, according to actual operational needs, in other application scenes, the device control process can also be implemented among the user terminal 110, the server end 170, the gateway 150, and the smart device 130. For example, both the virtual device configuration data and the device control instruction are transmitted from server end 170 to gateway 150, as shown by the dashed line in FIG. 21, which does not constitute a specific limitation here.

During the above process, synchronization is executed by actions performed in gateway level, it is sufficiently ensured that synchronous execution of scene actions by multiple smart devices that establish a virtual device. This not only effectively enhances stability of device control, but also helps to improve quickness of multiple devices executing scene actions, achieves the purpose of uniformly controlling multiple devices by a user, reduces network latency for multiple devices executing scene actions, and further facilitates improving users' use experience.

Referring to FIG. 21, an embodiment of the present disclosure provides a device control method, taking application of this method in an electronic device as an example for illustration. Among them, the electronic device can be a server end, for example, the server end can be the gateway 150 in FIG. 1, and can also be the server end 170 in FIG. 1, which does not constitute a specific limitation here.

As shown in FIG. 21, the device control method can include the following steps:

Step 510, obtaining a scene control instruction for multiple devices.

Among them, the scene control instruction is used to instruct the multiple devices to respectively execute corresponding scene actions.

In a possible implementation, the scene control instruction includes at least a scene identifier of a scene, a device identifier of at least one device, and an action identifier of a scene action correspondingly executed in the scene by at least one device.

Obtaining the scene control instruction, in a possible implementation, specifically refers to receiving a scene control instruction for multiple devices, which is is sent from the user terminal. Among them, the scene control instruction is used to indicate that a target scene constructed in the user terminal is executed, the target scene has configured corresponding scene actions for the multiple devices. In this method, the scene control instruction is discussed aiming at the target scene being a controlled execution scene; the scene control instruction is generated when a user executes the target scene by one-click, and are then sent by the user terminal to the gateway to make the gateway control the devices to respectively execute corresponding scene actions configured in the controlled execution scene.

Obtaining the scene control instruction, in a possible implementation, specifically refers to receiving device state data sent by the multiple devices, the device state data is used to indicate device states of the devices; according to the received device state data, if it is determined that trigger conditions in device associated data are met, a scene control instruction for the multiple devices is generated according to scene actions correspondingly executed by the multiple devices in the device associated data. In this method, the scene control instruction is discussed aiming at automated scenes; when trigger conditions configured in an automated scene are met, the scene control instruction is generated by the gateway, so as to make the gateway control the devices to respectively execute corresponding scene actions configured in the automated scene.

Step 520, based on the scene control instruction, performing configuration detection of scene action record for the devices, determining at least one first device that has completed configuration and/or at least one second device that has not performed configuration.

Among them, the first device is a device that has been configured with scene action record. The second device is a device that has not performed configuration. The scene action record is record of scene actions that are configured to be allowed to be executed by a device in a scene.

In a possible implementation, configuration detection of scene action record refers to determining multiple devices according to device identifiers in a scene control instruction, and then determining whether each device stores a scene identifier of a scene and an action identifier of a scene action executed by the device in the scene, thereby determining whether each device has been configured with scene action record.

For example, for each device in the multiple devices determined according to the device identifiers in the scene control instruction, that the gateway performs configuration detection of scene action record for the device includes that: the gateway sends a configuration detection request relating to scene action record to the device; the device responds to the configuration detection request and returns a corresponding request response to the gateway, wherein the request response carries a scene identifier A stored in the device and an action identifier C3 of a scene action executed by the device in the scene, thus it is determined that the device has been configured with scene action record. That is, the scene action record records that the device executes a scene action represented by the action identifier C3 in the scene represented by the scene identifier A.

A device that has completed configuration is used as a first device, and a step 530 is executed, that is, in response to a scene control instruction, a scene action recorded by the first device in the scene action record is executed.

A device that has not performed configuration is used as a second device, and a step 550 is executed, that is, in response to a device control instruction corresponding to a scene control instruction, a scene action configured by the second device in the scene is executed.

Step 530, using at least one first device as a multicast member, sending a scene control instruction to the multicast member to instruct the multicast member to respond to the scene control instruction and synchronously execute a scene action recorded by the multicast member in the scene action record.

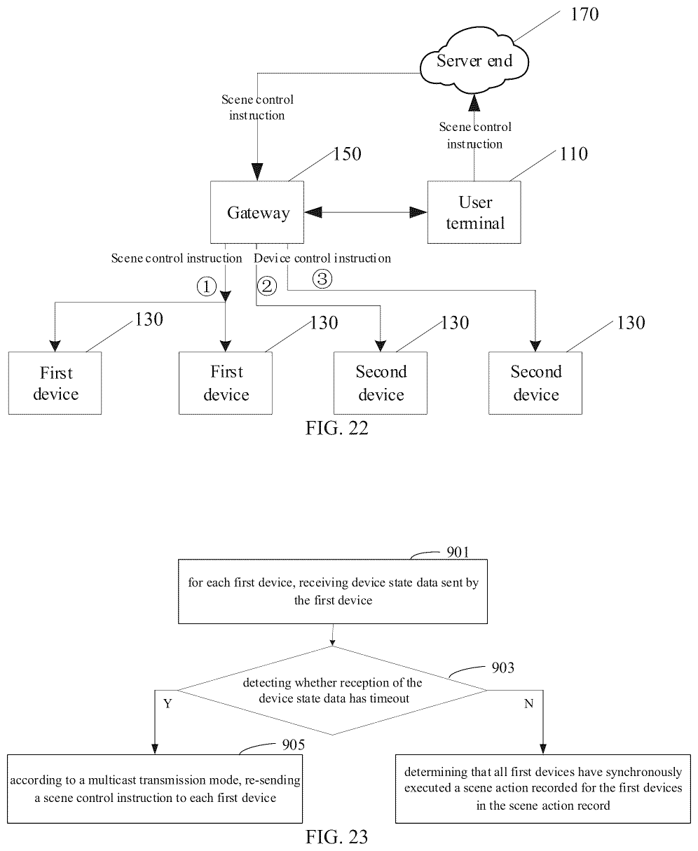

FIG. 22 shows a schematic diagram of a gateway respectively sending different instructions to a first device and a second device. In FIG. 22, since the two first devices have completed configuration of scene action record, that is, the two second devices record scene actions correspondingly executed in the scene by them, for the two first devices, the gateway 150 essentially performs control through a scene control instruction (instruction \textcircled{1}) in a multicast transmission method, thereby realizing that the two first devices synchronously execute scene actions relating to themselves in the scene action record.

Step 550, respectively sending a device control instruction corresponding to a scene control instruction to the second devices in a unicast transmission mode, thereby making the second devices respectively respond to the device control instruction and execute a corresponding scene action.

As mentioned above, for the second devices, they do not store any scene's scene identifier or any action identifier of a scene action executed in a scene by the second devices. Therefore, in a possible implementation, a device control instruction is extracted from a scene control instruction and includes at least a scene identifier of a scene and an action identifier of a scene action executed in the scene by a second device, so as to instruct the second device to execute the scene action in the scene.

Continuing referring to FIG. 22, since the two second devices have not completed configuration of scene action record, that is, the two second device do not know any scene action correspondingly executed in the scene by themselves, for the two second devices, the gateway sequentially sends two device control instructions (instruction \textcircled{2} and instruction \textcircled{3} to the second devices in a unicast transmission mode, such that the two second devices sequentially executes a scene action in the scene according to a sequence of receiving the device control instructions.

According to actual needs of network operation, in an application scene, a device control process is implemented among the user terminal, the server end, and the gateway, for example, scene control instructions are forwarded from the server end to the gateway. In another application scene, a device control process can also be implemented between the user terminal and the gateway, for example, scene control instructions are sent from the user terminal to the gateway.

Through the above process, with respect to the second devices that have not performed configuration, device control is not improved, the gateway still needs to sequentially sent multiple instructions to control the multiple second devices one by one; with respect to the first devices that have performed configuration, device control is greatly improved, that is, the gateway only needs to send one instruction, the multiple first devices can be simultaneously controlled to execute multiple actions. Thus multiple devices are avoided from sequentially executing an action in a scene, with increase of the number of the devices, it is more conducive to reduce network latency of multiple devices executing scene actions, thereby achieving effect of simultaneously and quickly controlling multiple devices, which is conducive to greatly improve users' use experience, for example, a user desires multiple devices to act uniformly to achieve effect of consistency of actions, rather than to act sequentially.

Furthermore, configuration of scene action record is not only applicable to multiple devices executing the same action, but also applicable to multiple devices executing different actions, universality of device control is effectively expanded.

Referring to FIG. 23, in an exemplary embodiment, the device control method can further include the following steps.

Step 901, for each first device, receiving device state data sent by the first device.

Among them, the device state data is used to indicate a device state of the first device after executing a scene action. For example, a scene is a bathroom, if a smart fan executes a turning-off action, the device state data is used to indicate that a device state of the smart fan is OFF; or if a smart light executes a turning-on action, the device state data is used to indicate that a device state of the smart light is ON.

Step 903, detecting whether reception of the device state data has timeout.

Compared with the gateway, timeout of reception of the device state data is also timeout of reporting the device state data by the first devices. If it is detected that at least one first device has timeout when reporting the device state data, the step 905 is executed. On the contrary, if it is detected that no first device has timeout when reporting the device state data, it is determined that all first devices have synchronously executed a scene action recorded for the first devices in the scene action record.

Step 905, according to a multicast transmission mode, re-sending a scene control instruction to each first device.

In a possible implementation, a scene control instruction is re-sent to all first devices. In a possible implementation, a scene control instruction is re-sent to first devices having timeout when reporting the device state data, until it is determined that all first devices have synchronously executed a scene action recorded for the first devices in the scene action record. Not only can success rate of executing the scene action be ensured to the maximum extent, thereby ensuring success rate of controlling the devices, but also stability of controlling the devices is ensured sufficiently.

It should be noted that for each first device, some first devices may have already executed the scene action, and reporting of the device state data thereof has no timeout, thus these first devices can ignore a re-received device control instruction. However, for first devices which have not executed the scene action or of which reporting of the device state data has timeout, it is needed to respond the re-received device control instruction again and re-execute the scene action recorded for the first devices in the scene action record.

In the above process, detection for reporting device states is realized. Through the timeout re-sending mechanism, the first devices are enabled to receive a scene control instruction again and thereby controlled again, in order to be capable of executing the scene action again; thereby enhancing system robustness and improving stability of controlling devices.

In a further embodiment, the scene control instruction can include a virtual device control instruction used to instruct a virtual device to execute a set scene action, the virtual device is established by at least two smart devices allowed to execute at least one identical scene action, the set scene action belongs to scene actions recorded by the at least two first devices.

The obtaining a scene control instruction for multiple devices includes: receiving the virtual device control instruction.

The sending the scene control instruction to the first devices in a multicast transmission mode to instruct the first devices to respond to the scene control instruction and synchronously execute a scene action recorded for the first devices in the scene action record includes: sending the virtual device control instruction to at least two first devices that establish the virtual device in the multicast transmission mode, such that the at least two first devices that establish the virtual device respond to the scene control instruction and synchronously execute the set scene action.

Among them, before the sending the virtual device control instruction to at least two first devices that establish the virtual device in the multicast transmission mode, the device control method further includes: based on the virtual device control instruction, performing virtual device configuration detection for the at least two first devices that establish the virtual device to determine at least one first device that has completed virtual device configuration.

The sending the virtual device control instruction to at least two first devices that establish the virtual device in the multicast transmission mode includes: using at least one of the first devices as a multicast member, and sending the virtual device control instruction to the multicast member.

Among them, before the sending the virtual device control instruction to at least two first devices that establish the virtual device in the multicast transmission mode, the device control method further includes: for at least one second device that has not completed virtual device configuration in the multiple devices, sending the virtual device control instruction to each second device respectively in a unicast transmission mode, such that each second device respectively responds to the virtual device control instruction and execute the set scene action.

Among them, before the based on the virtual device control instruction, performing virtual device configuration detection for the at least two first devices that establish the virtual device to determine at least one first device that has completed virtual device configuration, the device control method further includes: receiving virtual device configuration data sent by at least one of the first devices, wherein the virtual device configuration data is used to indicate that the virtual device is established by at least two first devices that record at least one identical scene action; based on the virtual device configuration data, requesting the first devices that establish the virtual device to perform virtual device configuration.

Among them, after the sending the virtual device control instruction to at least two first devices that establish the virtual device in the multicast transmission mode, the device control method further includes: for each of the first devices that establish the virtual device, receiving device state data reported by the first device, wherein the device state data is generated by the first device responding the virtual device control instruction to execute the set scene action, and used to indicate a device state of the first device after executing the set scene action; if it is detected that the reporting of the device state data has timeout, re-sending the virtual device control instruction to the at least two first devices that establish the virtual device in the multicast transmission mode.

Among them, the device control method further includes: based on the virtual device control instruction, performing virtual device marking process for the at least two first devices that establish the virtual device, so as to control the at least two first devices to maintain the same device state when device states of the at least two first devices are different.

The following are apparatus embodiments of the present disclosure, which can be used to execute the device control methods involved by the present disclosure. For details not disclosed in the apparatus embodiments of the present disclosure, please refer to the method embodiments of the device control method involved by the present disclosure.

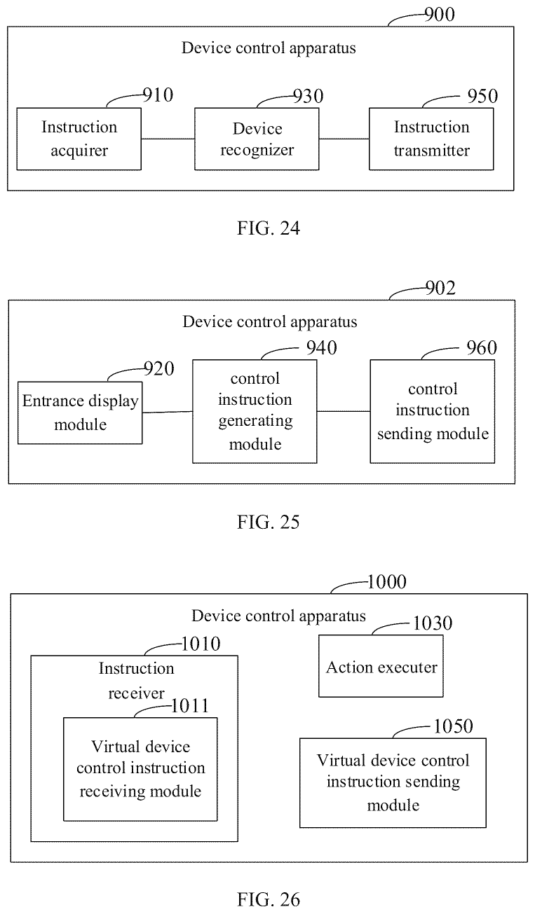

Referring to FIG. 24, an embodiment of the present disclosure provides a device control apparatus 900 deployed in a server end, the device control apparatus 900 includes but is not limited to an instruction acquirer 910, a device recognizer 930, and an instruction transmitter 950.

Among them, the instruction acquirer 910 is configured for obtaining a scene control instruction for multiple devices, wherein the scene control instruction is configured to instruct the multiple devices to execute corresponding scene actions respectively.

The device recognizer 930 is configured for identifying first devices in the multiple devices, wherein the first device is a device that has been configured with scene action record associated with the scene control instruction.

The instruction transmitter 950 is configured for: if at least one first device is identified, sending the scene control instruction to the first devices in a multicast transmission mode to instruct the first devices to respond to the scene control instruction and synchronously execute a scene action recorded for the first device in the scene action record.

Referring to FIG. 25, an embodiment of the present disclosure further provides a device control apparatus 902 deployed in a user terminal, the device control apparatus 902 includes but is not limited to an entrance display module 920, a control instruction generating module 940, and a control instruction sending module 960.

Among them, the entrance display module 920 is configured for displaying at least one control entrance for a virtual device, wherein the virtual device is established by at least two devices that are allowed to execute at least one identical scene action.

The control instruction generating module 940 is configured for: in response to a trigger operation for the control entrance, generating a virtual device control instruction, wherein the virtual device control instruction is configured to instruct the virtual device to execute a set scene action corresponding to the control entrance, wherein the set scene action belongs to scene actions that are allowed to be executed by the at least two devices establishing the virtual device.

The control instruction sending module 960 is configured for sending the virtual device control instruction to the virtual device, such that the at least two device establishing the virtual device respond the virtual device control instruction and synchronously execute the set scene action.

Referring to FIG. 26, an embodiment of the present disclosure provides a device control apparatus 1000 deployed in a smart device, the device control apparatus 1000 includes but is not limited to an instruction receiver 1010 and an action executer 1030.

Among them, the instruction receiver 1010 is configured for receiving a scene control instruction for multiple devices, wherein the scene control instruction is configured to instruct the multiple devices to execute corresponding scene actions respectively.

The action executer 1030 is configured for: based on configured scene action record associated with the scene control instruction, and in response to the scene control instruction, executing a scene action related to the smart device oneself in the scene action record.

The instruction receiver 1010 can further include a virtual device control instruction receiving module 1011, the device control apparatus 1000 can further include a virtual device control instruction sending module 1050.

Among them, the virtual device control instruction receiving module 1011 is configured for receiving a virtual device control instruction sent from a user terminal, wherein the virtual device control instruction is used to instruct the virtual device to execute a set scene action, the virtual device is established by at least two smart devices allowed to execute at least one identical scene action, the set scene action belongs to scene actions that are allowed to be executed by the at least two devices.

The virtual device control instruction sending module 1050 is configured for sending the virtual device control instruction to the at least two smart devices establishing the virtual device in a multicast transmission mode, such that the at least two smart devices establishing the virtual device respond to the virtual device control instruction and synchronously execute the set scene action.

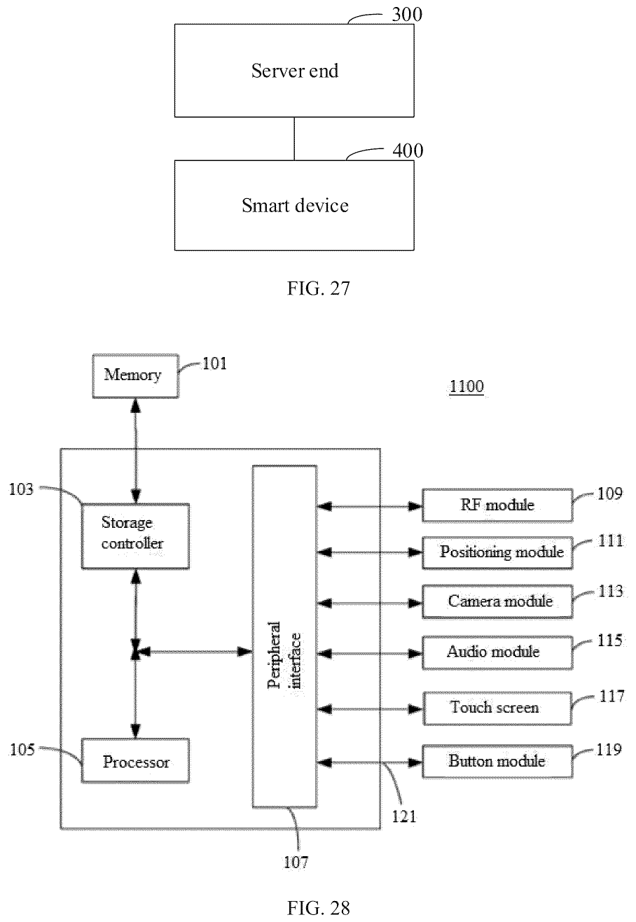

Referring to FIG. 27, an embodiment of the present disclosure provides a device control system, the system includes but is not limited to a server end 300 and a smart device 400.

Among them, the server end 300 is configured for: obtaining a scene control instruction for multiple smart devices, and in a case that at least one first device is identified in the multiple smart devices, sending the scene control instruction to the first devices in a multicast transmission mode; wherein the scene control instruction is used to instruct the smart devices to respectively corresponding scene actions, and the first devices are smart devices that have been configured with scene action record.

The smart device 400 is configured for: in response to a received scene control instruction, based on configured scene action record, executing a scene action relating to itself in the scene action record.

It should be noted that the device control device or system provided by the above embodiments are only illustrated with examples according to the division of the above functional modules when performing device control. In practical applications, the above functions can be assigned to be completed by different functional modules as needed, that is, the internal structure of the device control device or system will be divided into different functional modules to complete all or some of the functions described above.

In addition, the device control device or system provided by the above embodiments belongs to the same concept as the embodiments of the device control method, and the specific ways in which each module performs operations have been described in detail in the method embodiments, which will not be repeated here.

Referring to FIG. 28, FIG. 28 is a structural schematic diagram of an electronic device shown according to an exemplary embodiment. The electronic device is applicable to the user terminal 110 in the implementation environment shown in FIG. 1.

It should be noted that this electronic device is only an example adapted to the present disclosure and cannot be considered as providing any limitation to the use scope of the present disclosure. The electronic device cannot be interpreted as requiring relying on or necessarily having one or more components of the exemplary electronic device 1100 shown in FIG. 28.

As shown in FIG. 2, the terminal 1100 includes a memory 101, a storage controller 103, one or more (only one is shown in FIG. 28) processors 105, a peripheral interface 107, a radio frequency module 109, a positioning module 111, a camera module 113, an audio module 115, a touch screen 117, and a button module 119. These components communicate with each other through one or more communication buses/signal lines 121.

In some embodiments, the terminal 1100 further includes one or more sensors (not shown in FIG. 28), the one or more sensors include but are not limited to an acceleration sensor, a gyroscope sensor, a pressure sensor, a fingerprint sensor, an optical sensor, a proximity sensor, and the like.

It can be understood that the structure shown in FIG. 28 is only illustrative, and the terminal 1100 may also include more or fewer components than those shown in FIG. 28, or have components different from those shown in FIG. 28. The components shown in FIG. 28 can be implemented using hardware, software, or a combination thereof.

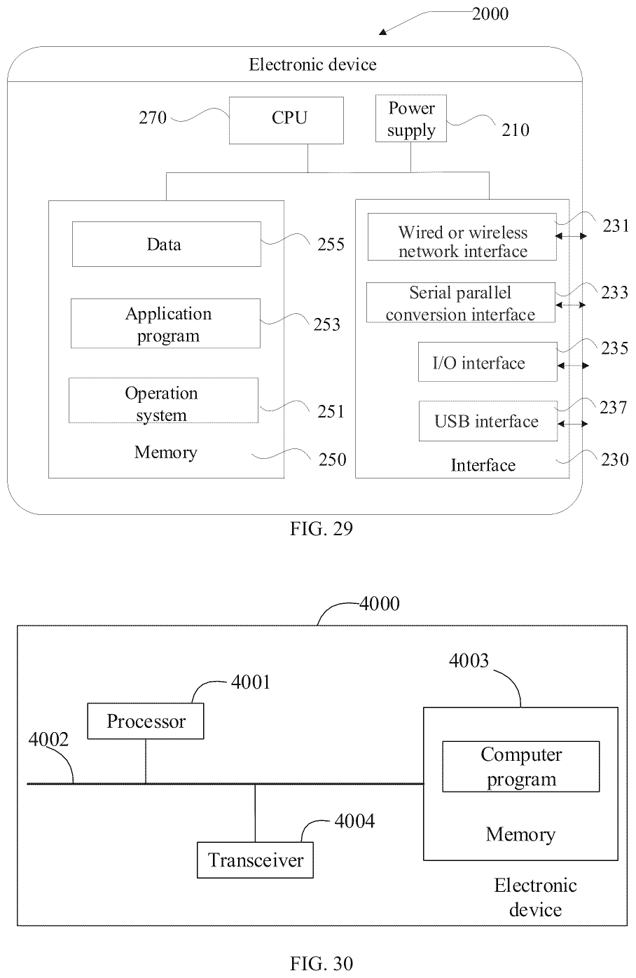

FIG. 29 is a structural schematic diagram of an electronic device shown according to an exemplary embodiment. The electronic device is applicable to the smart device 130, the gateway 150, and the server end 170 in the implementation environment shown in FIG. 1.

It should be noted that this electronic device is only an example adapted to the present disclosure and cannot be considered as providing any limitation to the use scope of the present disclosure. The electronic device cannot be interpreted as requiring relying on or necessarily having one or more components of the exemplary electronic device 2000 shown in FIG. 29.

The hardware structure of the electronic device 2000 may vary greatly due to differences in configuration or performance, as shown in FIG. 29, the electronic device 2000 includes a power supply 210, an interface 230, at least one memory 250, and at least one central processing unit (CPU) 270.

In addition, the present disclosure can also be implemented through hardware circuits or a combination of hardware circuits and software. Therefore, the implementation of the present disclosure is not limited to any specific hardware circuit, software, or combination of the two.

Referring to FIG. 30, an embodiment of the present disclosure provides an electronic device 4000, the electronic device 4000 can include a smart device, a gateway, a server, and so on.

In FIG. 30, the electronic device 4000 includes at least one processor 4001, at least one communication bus 4002, and at least one memory 4003.

The memory 4003 stores computer readable instructions, the processor 4001 can read the computer readable instructions stored in the memory 4003 through the communication bus 4002.

The computer readable instructions, when being executed by the processor 4001, implements the device control methods in the above embodiments.

Additionally, an embodiment of the present disclosure provides a storage medium, the storage medium stores computer readable instructions, and the computer readable instructions are loaded and executed by a processor to implement the aforesaid device control methods.

An embodiment of the present disclosure provides a computer program product, the computer program product includes computer readable instructions, the computer readable instructions are stored in a storage medium, a processor of a device reads the computer readable instructions from the storage medium, and loads and executes the computer readable instructions to make the device implement the aforesaid device control methods. Among them, the computer program product can use any programming language and take the form of source codes, object codes, or intermediate codes between source codes and object codes, such as partially compiled form or any other required form.

Compared with the related art, in the above embodiments of the present disclosure, a scene action executed correspondingly by at least one device in a scene is recorded by the way of scene action record and configured for at least device in the scene; thus, during a device control process, a scene control instruction is sent to the devices in a multicast transmission mode, the devices can simultaneously execute a corresponding scene action according to scene actions recorded for the devices in the configured scene action record, thereby avoiding controlling multiple devices one by one based on multiple instruction, that is, avoiding multiple devices from sequentially executing corresponding scene actions. Thus, network latency of multiple devices executing multiple actions is reduced, such that the problem of large network latency of multiple devices executing multiple actions existing in the related art can be effectively solved. Furthermore, compared with the related art, by establishing multiple smart devices that are allowed to execute at least one identical scene action as a virtual device, controlling the virtual device to execute a set action is enabled to become controlling the multiple smart devices to synchronously execute the set action. Not only does it solve the popcorn problem (non-fast unified control), success rate problem (control failure), and consistency problem (not synchronous actions, but sequential actions) during processes of executing actions by multiple devices, but it also sufficiently and effectively improves convenience and flexibility of user operations, so that users' use experience can be effectively improved.

It should be understood that although the various steps in the flowcharts of the accompany drawings are displayed sequentially according to indication of the arrows, these steps are not necessarily executed sequentially in the sequence indicated by the arrows. Unless otherwise specified in this article, there is no strict order limit for execution of these steps, and they can be executed in other orders. Moreover, at least some of the steps in the flowcharts of the accompany drawings may include multiple sub-steps or multiple stages, these sub-steps or stages are not necessarily executed completely at the same time, but can be executed at different times. Their execution order is not necessarily sequential, but can be rotated or alternated with other steps, or at least some of sub-steps or stages of other steps.

The above described are only some embodiments of the present disclosure. It should be pointed out that for ordinary technical personnel in this field, multiple improvements and embellishments can be made without departing from the principles of the present disclosure. These improvements and embellishments should also be considered as the protection scope of the present disclosure.

What is claimed is:

1. A device control method executed by a server end, wherein the method comprises:
obtaining a scene control instruction for multiple devices, wherein the scene control instruction is configured to instruct the multiple devices to execute corresponding scene actions respectively;
identifying first devices in the multiple devices, wherein the first device is a device that has been configured with scene action record;
if at least one first device is identified, sending the scene control instruction to the first devices in a multicast transmission mode to instruct the first devices to respond to the scene control instruction and synchronously execute a scene action recorded for the first devices in the scene action record.

2. The method according to claim 1, wherein the obtaining a scene control instruction for multiple devices comprises:
receiving device state data sent by the multiple devices, wherein the device state data is configured to indicate device states of the devices;
according to the received device state data, if it is determined that trigger conditions in device associated data are met, generating a scene control instruction for the multiple devices according to scene actions correspondingly executed by the multiple devices in the device associated data.

3. The method according to claim 1, wherein the identifying first devices in the multiple devices comprises:
based on the scene control instruction, performing configuration detection of scene action record for the devices, determining at least one first device that has completed configuration and/or at least one second device that has not performed configuration;
the sending the scene control instruction to the first devices in a multicast transmission mode comprises:
using at least one first device as a multicast member, sending the scene control instruction to the multicast member.

4. The method according to claim 3, after the identifying first devices in the multiple devices, further comprising:
if at least one second device is identified, respectively sending a device control instruction corresponding to a scene control instruction to the second devices in a unicast transmission mode, thereby making the second devices respectively respond to the device control instruction and execute a corresponding scene action.

5. The method according to claim 1, after the sending the scene control instruction to the first devices in a multicast transmission mode, further comprising:
for each first device, receiving device state data sent by the first device, wherein the device state data is configured to indicate a device state of the first device after executing the scene action;
if it is detected that reception of the device state data of the first device has timeout, re-sending the scene control instruction to the first devices in the multicast transmission mode.

6. The method according to claim 1, further comprising:
receiving scene configuration data, wherein the scene configuration data indicates at least scene actions which are configured to be allowed to be executed by multiple devices;
based on the scene configuration data, requesting performing configuration of scene action record for a third device in multiple devices, wherein the third device is a device that supports the configuration of scene action record.

7. The method according to claim 6, wherein the based on the scene configuration data, requesting performing configuration of scene action record for a third device in multiple devices comprises:
based on multiple devices indicated by the scene configuration data, determining a third device in the multiple devices;
obtaining snapshot configuration data associated with the determined third device from the scene configuration data, wherein the snapshot configuration data is configured to indicate a scene action that is configured to be allowed to be executed by the third device;
sending the snapshot configuration data to the associated third device, making the third device performing configuration of scene action record according to the snapshot configuration data, wherein the third device is transformed into the first device that has completed configuration in a case that the configuration of scene action record is completed.

8. The method according to claim 1, wherein the scene control instruction comprises a virtual device control instruction configured to instruct a virtual device to execute a set scene action, the virtual device is established by at least two first devices that record at least one identical scene action, and the set scene action belongs to scene actions recorded by the at least two first devices;
the obtaining a scene control instruction for multiple devices comprises: receiving the virtual device control instruction;
the sending the scene control instruction to the first devices in a multicast transmission mode to instruct the first devices to respond to the scene control instruction and synchronously execute a scene action recorded for the first devices in the scene action record comprises:
sending the virtual device control instruction to at least two first devices that establish the virtual device in the multicast transmission mode, thereby making the at least two first devices that establish the virtual device respond to the scene control instruction and synchronously execute the set scene action.

9. The method according to claim 8, before the sending the virtual device control instruction to at least two first devices that establish the virtual device in the multicast transmission mode, further comprising:
based on the virtual device control instruction, performing virtual device configuration detection for the at least two first devices that establish the virtual device to determine at least one first device that has completed virtual device configuration;
the sending the virtual device control instruction to at least two first devices that establish the virtual device in the multicast transmission mode comprises:
using at least one of the first devices as a multicast member, and sending the virtual device control instruction to the multicast member.

10. The method according to claim 9, before the sending the virtual device control instruction to at least two first devices that establish the virtual device in the multicast transmission mode, further comprising:
for at least one second device that has not completed virtual device configuration in the multiple devices, sending the virtual device control instruction to each second device respectively in a unicast transmission mode, thereby making each second device respectively respond to the virtual device control instruction and execute the set scene action.

11. The method according to claim 9, before the based on the virtual device control instruction, performing virtual device configuration detection for the at least two first devices that establish the virtual device to determine at least one first device that has completed virtual device configuration, further comprising:
receiving virtual device configuration data, wherein the virtual device configuration data is configured to indicate that the virtual device is established by at least two first devices that record at least one identical scene action;
based on the virtual device configuration data, requesting the first devices that establish the virtual device to perform virtual device configuration.

12. The method according to claim 8, wherein after the sending the virtual device control instruction to at least two first devices that establish the virtual device in the multicast transmission mode, further comprising:
for each of the first devices that establish the virtual device, receiving device state data reported by the first device, wherein the device state data is generated by the first device responding the virtual device control instruction to execute the set scene action, and configured to indicate a device state of the first device after executing the set scene action;
if it is detected that reporting of the device state data has timeout, re-sending the virtual device control instruction to the at least two first devices that establish the virtual device in the multicast transmission mode.

13. The method according to claim 8, further comprising:
based on the virtual device control instruction, performing virtual device marking process for the at least two first devices that establish the virtual device, thereby controlling the at least two first devices to maintain the same device state when device states of the at least two first devices are different.

14. A device control method executed by a smart device, wherein the method comprises:
receiving a scene control instruction for multiple devices, wherein the scene control instruction is configured to instruct the multiple devices to execute corresponding scene actions respectively;
based on configured scene action record, and in response to the scene control instruction, executing a scene action related to the smart device oneself in the scene action record.

15. A device control method executed by a user terminal, wherein the method comprises:
displaying at least one control entrance for a virtual device, wherein the virtual device is established by at least two devices that are allowed to execute at least one identical scene action;
in response to a trigger operation for the control entrance, generating a virtual device control instruction, wherein the virtual device control instruction is configured to instruct the virtual device to execute a set scene action corresponding to the control entrance, wherein the set scene action belongs to scene actions that are allowed to be executed by the at least two devices establishing the virtual device;
sending the virtual device control instruction to the virtual device, thereby making the at least two device establishing the virtual device respond the virtual device control instruction and synchronously execute the set scene action.

16. The method according to claim 5, wherein in the at least two devices establishing the virtual device, one of the devices serves as a target device, and the remained devices serve as candidate devices;
before the displaying at least one control entrance for a virtual device, the method further comprises:
displaying the target device in a device list page;
determining at least one of the candidate devices based on the virtual device establishing instruction for the target device;
displaying the virtual device established by the target device and at least one of the candidate devices in the device list page.

17. The method according to claim 16, before the determining at least one of the candidate devices based on the virtual device establishing instruction for the target device, further comprising:
displaying a virtual device establishing entrance corresponding to the target device;
in response to a trigger operation to the virtual device establishing entrance, generating the virtual device establishing instruction.

18. The method according to claim 16, wherein the determining at least one of the candidate devices based on the virtual device establishing instruction for the target device comprises:
in response to the virtual device establishing instruction, displaying at least one recommended device, wherein the recommended device is a first device of which at least one scene action allowed to be executed is the same as that of the target device;
in response a second selection operation for at least one displayed recommended device, determining a selected recommended device as the determined candidate device.

19. The method according to claim 15, wherein the displaying at least one control entrance for a virtual device comprises:
in response to a third selection operation for the virtual device displayed in a device list page, displaying a device detail page of the virtual device;
displaying at least one control entrance in the device detail page of the virtual device.

20. The method according to claim 15, wherein set scene actions corresponding to different control entrances have different scene action types, and the at least two devices establishing the virtual device are configured to respond the virtual device control instruction to synchronously execute a set scene action matching a scene action type supported by themselves; wherein the scene action type supported by the at least two devices themselves is configured to indicate a scene action recorded by the at least two devices.
